(19) United States
(12) Patent Application Publication
(10) Pub. No.: US 2024/0370915 A1
(43) Pub. Date: Nov. 7, 2024

(54) Consumer Purchasing and Inventory Control Assistant Apparatus, System and Methods

(71) Applicant: TACO MARKETING LLC, Fort Myers, FL (US)

(72) Inventors: Todd B. Ferguson, Fort Myers, FL (US); Andrew M. Czachowski, Greenfield, WI (US)

(21) Appl. No.: 18/560,660

(22) PCT Filed: May 13, 2022
(86) PCT No.: PCT/US2022/029233

§ 371 Date: Nov. 13, 2023

Related U.S. Application Data
(60) Provisional application No. 63/188,557, filed on May 14, 2021.
(60) Provisional application No. 63/281,841, filed on Nov. 22, 2021.

(51) Int. Cl. G06Q 30/0601

(52) U.S. Cl. CPC G06Q 30/0629; G06Q 30/0631; G06Q 30/0633

(57) ABSTRACT

In one aspect a method is provided for providing a user with offers to purchase merchandise. The method comprises monitoring browsing activity of a user on a web browser application of a user device via a web browser extension. Further, determining a. product of interest to the user based at least in part on the browsing activity and displaying, via the user device, an offer to purchase a comparable product to the determined product of interest. Upon receiving an indication from a user to accept the offer, adding the comparable product to a virtual shopping cart associated with the user and the web browser extension.

### CROSS-REFERENCE TO RELATED APPLICATIONS

This application claims the benefit of U.S. Provisional Application No. 63/188,557, filed May 14, 2021, and U.S. Provisional Application No. 63/281,841, filed Nov. 22, 2021, which are both hereby incorporated herein by reference in their entireties.

### TECHNICAL FIELD

This invention relates generally to consumer purchasing and, more particularly, apparatus and systems for online purchasing and methods relating thereto.

### BACKGROUND

E-commerce is becoming an increasingly popular way for consumers to purchase all kinds of goods. While it has long been common to purchase specialty goods online, many online stores are expanding into common household goods, such as groceries and toiletries. However, with so many online stores offering the same goods and each of those stores having dynamic prices, it can be difficult for a consumer to find the best deal. Additionally, many stores or sellers offer better prices to bulk purchasers.

In conventional price comparison products, software or services, it is known to search the internet for a particular product by its barcode, name or other identifying indicia to locate comparable prices, however, such systems require the user to actively submit the information being searched and/or they fail to recognize standard forms (e.g., estimates, purchase orders, invoices, proposals, etc.). In addition, conventional systems can easily be thwarted by changing the location of certain data on a form to prevent the form from being machine readable or recognizable due to a change from a prior format. Conventional systems typically rely on manual data entry from users to determine what products are being searched for. However, this data is already present on purchase orders, request form, existing quotes, or some other piece of documentation.

Conventional inventory control systems have similar shortcoming where they require the user to actively submit the information being stocked and manually update the inventory as the items are moved or used. When inventory runs low, the user must manually order replacements. Alternatively, the user can estimate their rate of consumption and manually create a subscription to reorder at a set rate.

Accordingly, it has been determined that the need exists for an improved consumer purchasing assistant apparatus and inventory control apparatus, system and related methods which overcomes the aforementioned limitations, and which further provides capabilities, features and functions, not available in current products, services and methods.

### BRIEF DESCRIPTION OF THE DRAWINGS

FIGS. 1A-1B show a flow diagram of an apparatus, system and/or method for assisting in consumer purchasing;

FIGS. 2A-2B show a flow diagram of an apparatus, system and/or method for assisting in consumer purchasing;

FIG. 3 is a screenshot from an example apparatus, system and/or method for assisting in consumer purchasing;

FIG. 4 is a screenshot from an example system for assisting in consumer purchasing;

FIG. 5 is a screenshot from an example system for assisting in consumer purchasing;

FIG. 6 is a screenshot from an example system for assisting in consumer purchasing;

FIGS. 7A-7F show flow diagrams of an apparatus, system and/or method for assisting in inventory management;

FIG. 8A is a block diagram of a shelf with weight sensors;

FIG. 8B is a side view block diagram of the shelf of FIG. 8A;

FIG. 9A is a flow diagram of an apparatus, system and/or method for assisting in consumer purchasing;

FIG. 9B is a flow diagram of an apparatus, system and/or method for parsing a document;

FIG. 10 is a flow diagram of an apparatus, system and/or method for organizing messages;

FIG. 11 is a flow diagram of an apparatus, system and/or method for an awards system;

FIGS. 12A-12B are flow diagrams of an apparatus, system and/or method for assisting in consumer purchasing;

FIG. 13 is a flow diagram of an apparatus, system, and/or method for facilitating purchase consideration of the products of local businesses;

FIG. 14 is an example block diagram of the association of various credit/debit cards to a user account associated with a consolidated card;

FIG. 15 is a block diagram of an example system using the consolidated card of FIG. 14;

FIG. 16 is a flow diagram of an apparatus, system and/or method for applying a credit/debit card to a transaction;

FIG. 17 is a flow diagram of an apparatus, system, and/or method for providing online shoppers with offers to purchase comparable products from another seller;

FIG. 18 is flow diagram of an apparatus, system, and/or method for providing online shoppers the ability to conclude a purchase from a plurality of different vendors with a single purchase transaction; and

FIG. 19 is a screenshot from an example system for assisting in consumer purchasing.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

In accordance with one aspect of the present disclosure, a system is provided for assisting consumer purchasing. An example system receives an input, such as a purchase order, invoice, or other document, indicating a desired product or list of products. This list is parsed, and the system identifies online listings of the products for sale and identifies the cheapest. The system additionally searches for sales, coupons, group buy opportunities, and other means of decreasing the sale price. In one form, the system maintains a list of desired products, and periodically performs another search to identify the cheapest seller. When the cheapest price drops, the user is notified. In another form, the system forms a group comprising a plurality of users who desire the same product in order to form a bulk purchase. The users are informed of the current size of the group and the required size in order to qualify for the group buy discount. The users are periodically updated as the group grows until it reaches the purchase size.

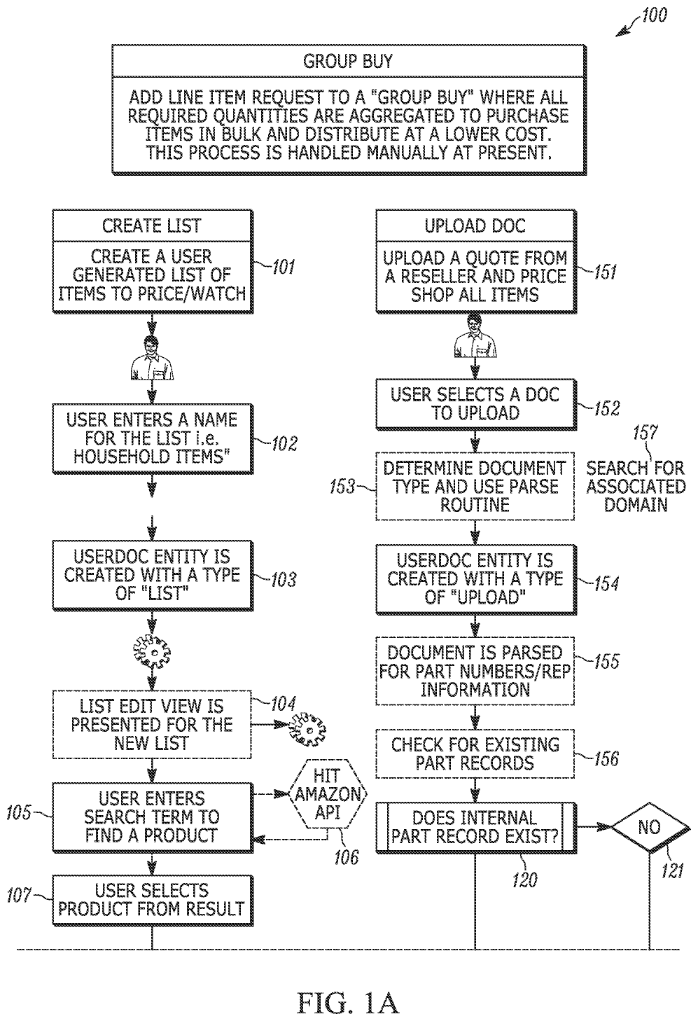

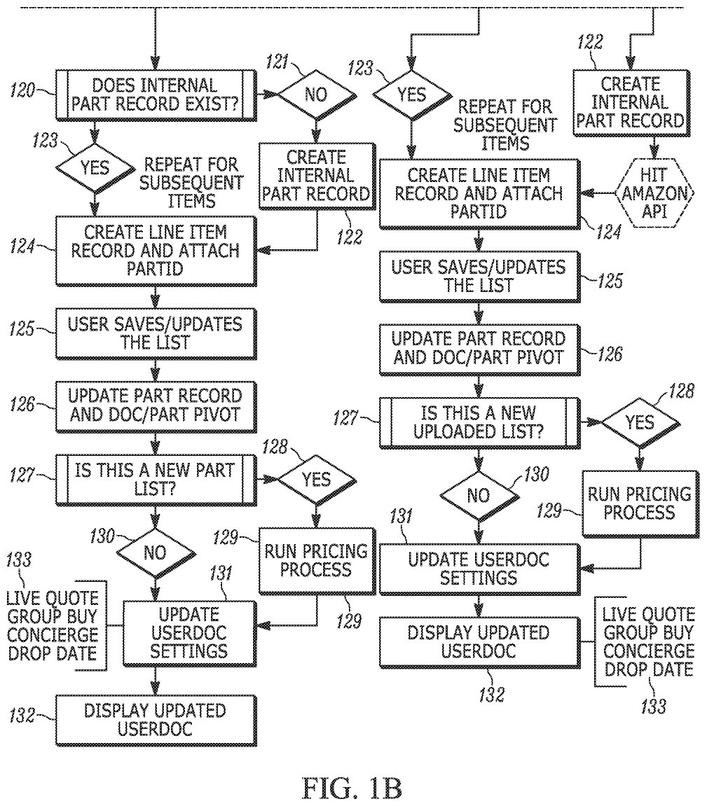

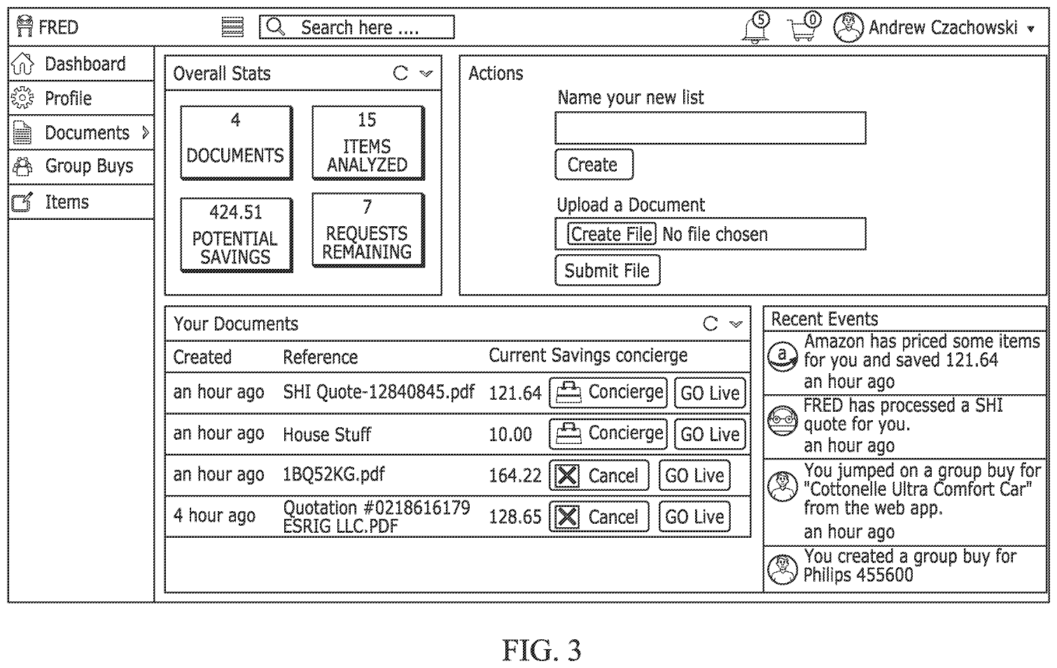

FIGS. 1A-1B illustrate a flow chart of the group buy process 100. To start, the user can either upload a document having a list or start a new list on the system from the dashboard, see FIG. 3. If the user opts to create 101 a list on the system, they input 102 a title for the list. The system then forms 103 a blank list which they can edit 104 by adding search terms to find the desired products. As they enter 105 the search terms, a list of available products is generated by the system from which the user selects 107 the product they are searching for. In one form, the search utilizes 106 an Amazon API gateway. This product is then added to the list. These steps are repeated until the list is fully formed.

Instead, a user may decide to upload 151 an existing list. Exemplary lists include inventory databases or price sheets from resellers. First, the user selects 152 a document to upload. The system determines the document type and then parses 153 it. In some forms, information parsed from the list is used to search 157 for an associated domain. For example, the domain of a reseller associated with the types of products identified in the parsing process or the domain of a reseller specifically identified in the uploaded document. A new document is formed 154 to store the data that is parsed from this uploaded document. The parsing 153 identifies and extracts 155 product identifying information, such as part numbers, or product names. The parsed information is then checked 156 against existing records containing lists of available products in order to form a list on the system.

Once a list is formed on the system, the system checks 120 for an internal part record of each product. For any products that do not 121 already have an internal part record, one is created 122. Once each product on the list has 123 an internal part record, a line item record is created 124 with the part ids of the products attached. The user can then save 125 the list. The list us editable, so that the user can add or remove products to it at any time. When the list is saved and updated, the system updates 126 the part record.

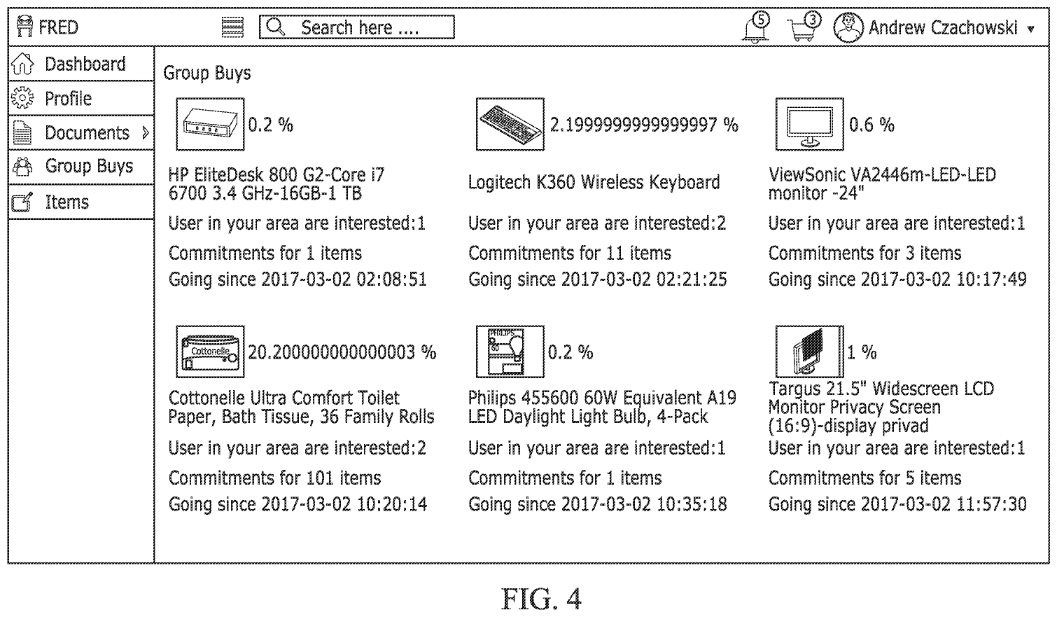

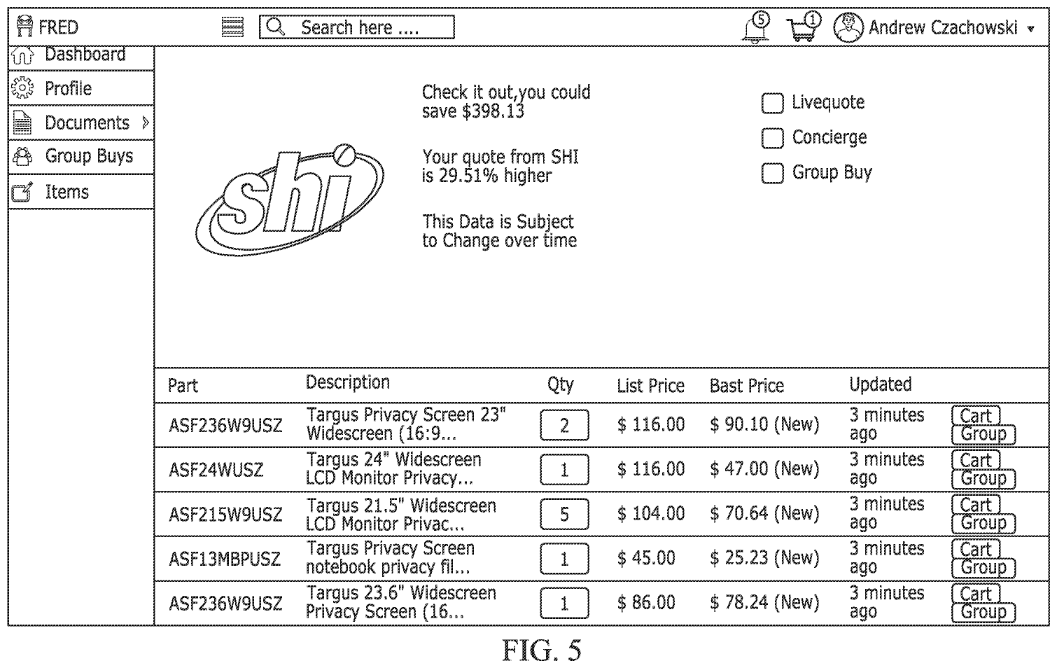

The system determines 127 if a new list or newly updated list with a new part is uploaded. If so 128, a pricing process is run 129 on the newly added products to identify the best deals, such as group buys. Regardless of whether 128 or not 130 the update included a new list or new parts, the document settings are updated 131 to reflect the update. The updated document is displayed 132 to the user. Live quotes for available groups for the products are identified 133 on a group buys page of the user portal to the system, see FIG. 4. The user can then join the groups so that they product can be purchased at the wholesale price once the group is large enough.

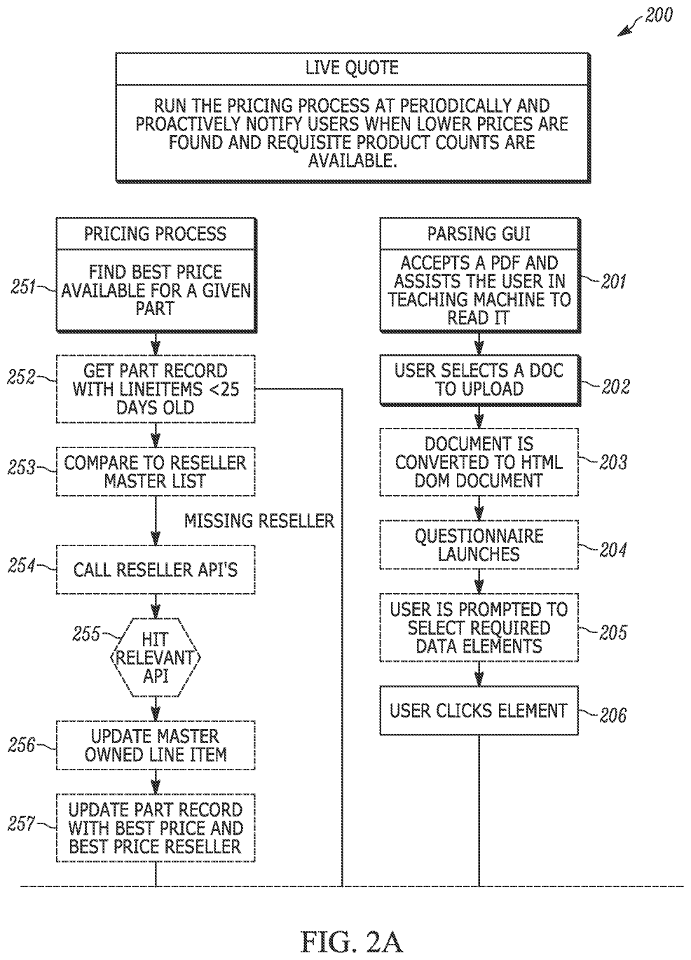

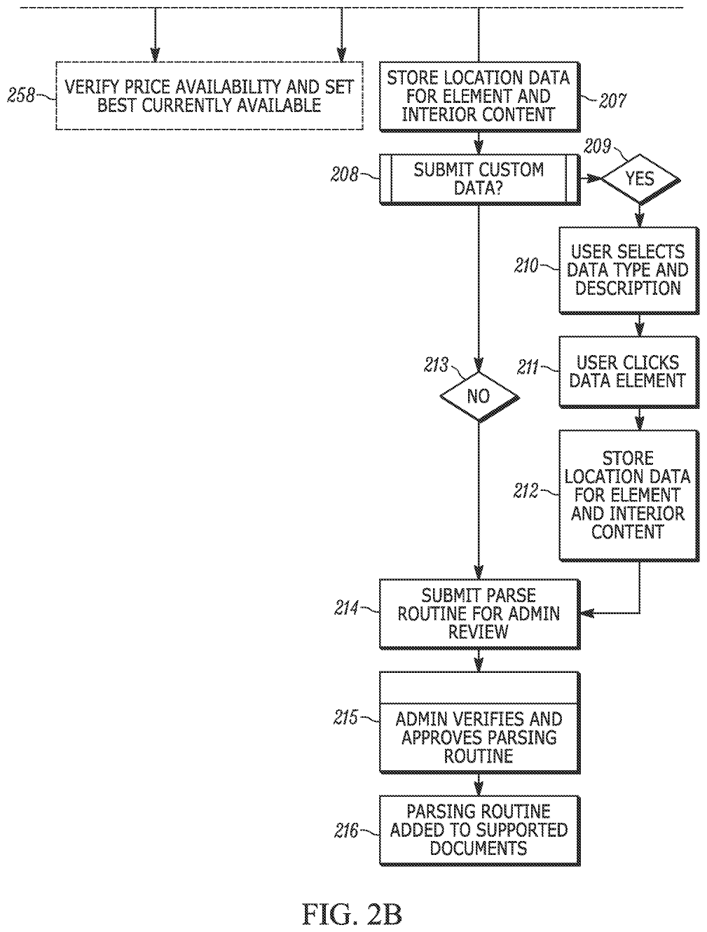

FIGS. 2A-2B are a flowchart of a process 200 for monitoring prices. The pricing process keeps a list of products desired by the user, and periodically searches available sellers to find the best price available. The process includes a parsing graphical user interface 201 which accepts a document from the user and then learns to read the document with the help of the user. As with the above process, the user can input an existing list by selecting 202 a saved document and uploading the document. In some forms, the document is automatically identified and uploaded without user input. For example, the system includes a web browser extension that monitors the user's online shopping activities and/or emails to identify purchases and attempted purchases. In some forms, the extension uploads products to the live quote system 200 as they are added to an online shopping cart, and then a live quote is provided in real time if better prices are available elsewhere.

The document is converted 203 from the uploaded document type, such as a PDF, to a HTML document. The system then parses the document to identify the listed products. In one form, parsing involves asking the user questions to help identify the products. The questions are displayed 204 via the user portal and the answers are input by the user. Specifically, the user is prompted 205 to select the required data elements from the document. As the required elements are listed, such as part number, quantity, etc., the user clicks 206 on where the element is located on the document. The data parsed form the clicked portion of the document is stored 207 in a portion of memory associated with that element. If the product cannot be identified by the automated questionnaire, the user can input custom data to help identify the product. The custom data is reviewed by a system admin to identify the products. To utilize custom data, the system first determines 208 if custom data is needed. If so 209, the user selects 210 the data type and description from a list. The user then clicks 211 on the data element corresponding to the selected data type. The system stores 212 the location data within the document of the data element.

After the data is all entered, regardless of whether 209 or not 213 custom data was required, the parse routine is submitted 214 for review by a system administrator. The administrator verifies and approves 215 the parsing routine, at which point it is added 216 to the supported document. Adding 216 the parsing routine to the supported documents, allows future documents of that type to be parsed automatically without the need for user inputs through a questionnaire or custom data.

The system crawls the web to identify 251 the best prices available for listed products. This includes searching the list price for sellers and resellers as well as identifying sales literature, coupons, and other price reducing means. In some forms, other methods of acquiring price information is used in addition to or instead of crawling the web. For example, a plurality of users upload documents having bid prices provided by resellers. The bid prices are parsed by the system and listed in the best price record, allowing the system to find prices even better than any publicly available on the internet.

For any price identified that is determined 252 to be less than a predetermined age, such as 25 days old (in other embodiments the age can be altered from 25 days to another length), the price is compared 253 to the master list of sellers kept by the system. If the reseller is already on the system, the price is updated in the master list. If the reseller is not in the system, the reseller is contacted 254 via the API. Contacting the reseller via the API involves first identifying 255 the correct API. The new reseller can then be added 256 to the master list. The master list is updated 257 to reflect the new best price and best price reseller. The master list prices are used to display the best available price to the user.

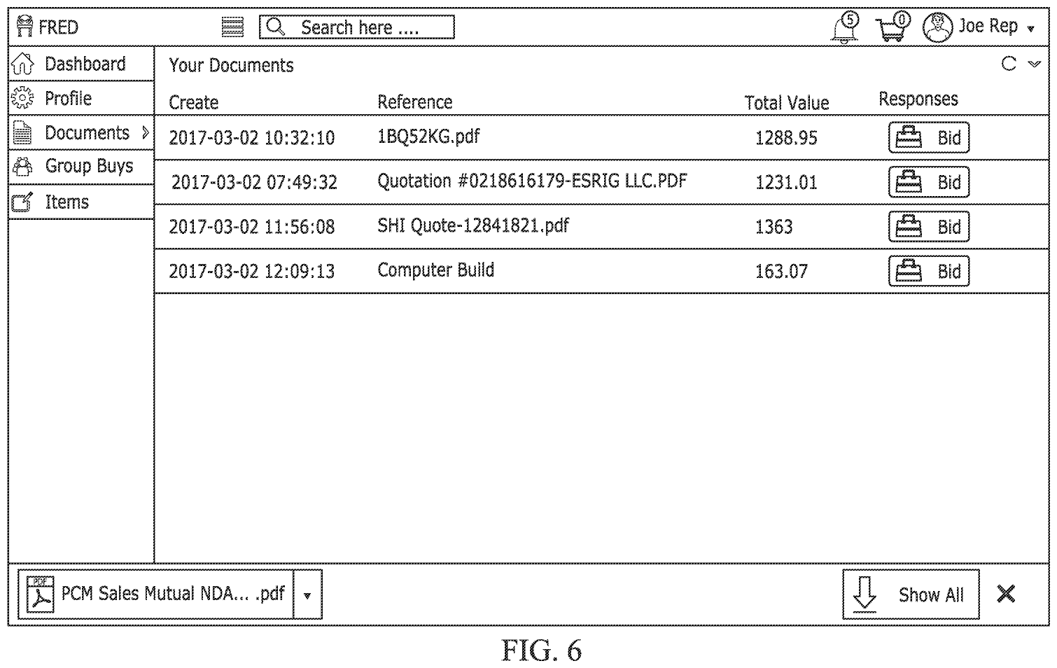

The system periodically runs this pricing process in order to identify the best deals for purchasing the listed products as well as to verify 258 the availability of the best price item. The prices are displayed to the user on the created list, see FIG. 6. In some forms, the user can identify a purchase price. Once the list price drops to or below the pre-identified purchase price, the products are automatically purchased in a predetermined quantity. The system additionally informs the user of any group buy opportunities for items on the list.

In addition to the methods of finding prices described above, the pricing process 251 in some forms includes a bidding process. A document containing the identity and quantity of products desired by the user are submitted to a number of resellers, distributors, or other representatives collectively known as concierge representatives. The concierge representatives return price bids to fulfill the order. In some forms, these price bids are then used to update the best price database for use for both the user associated with the list as well as other users.

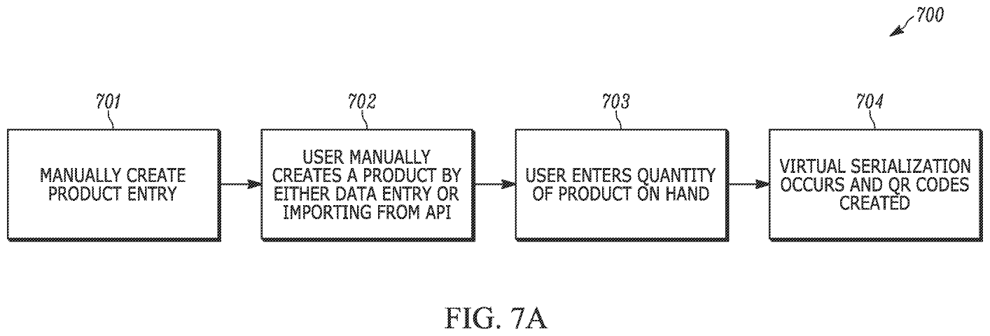

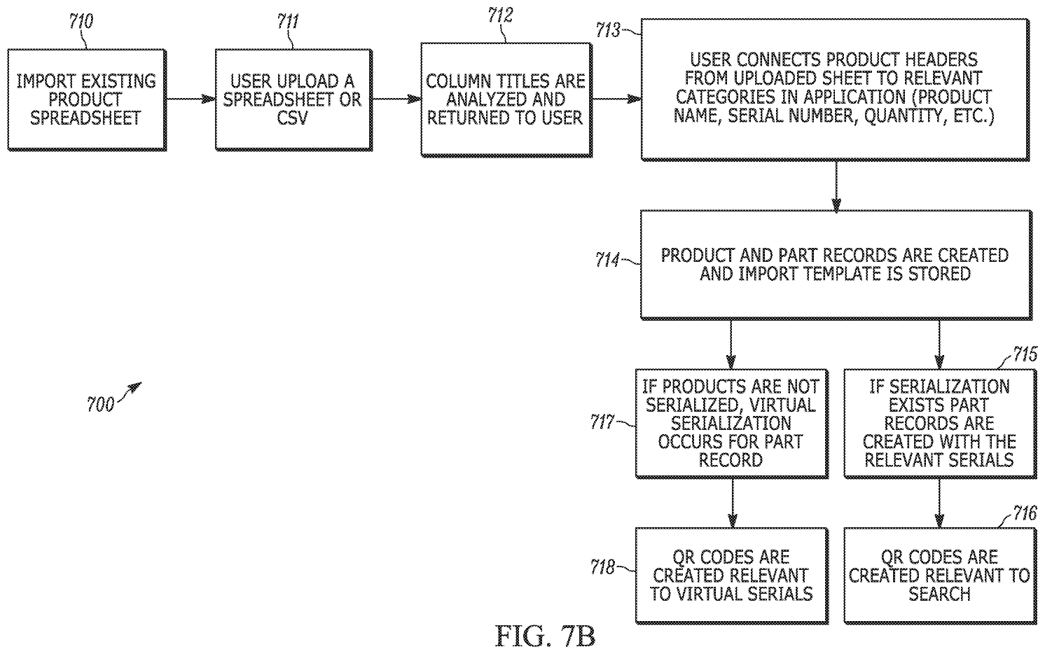

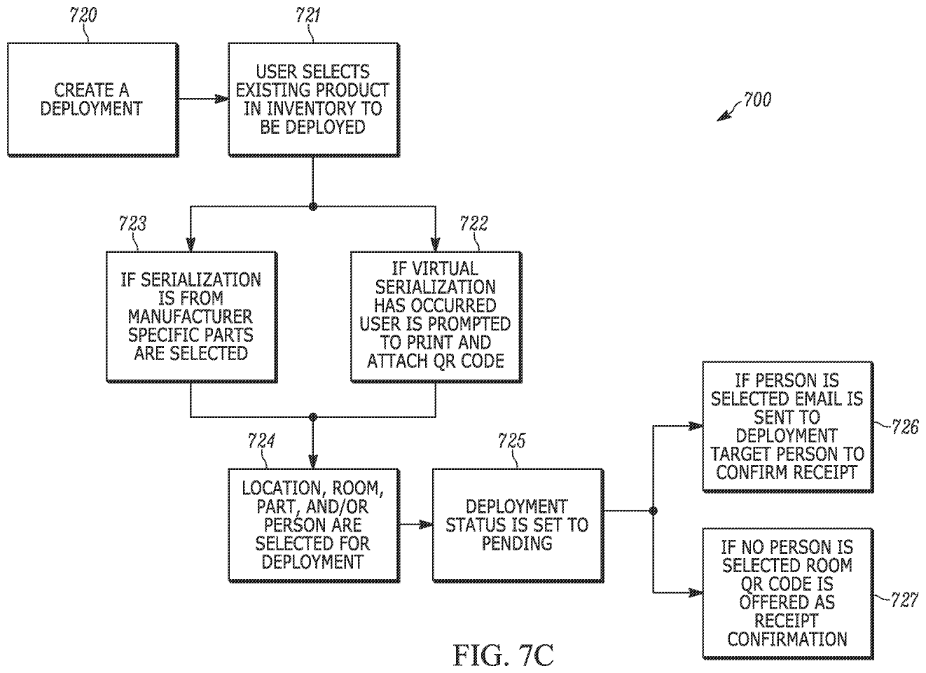

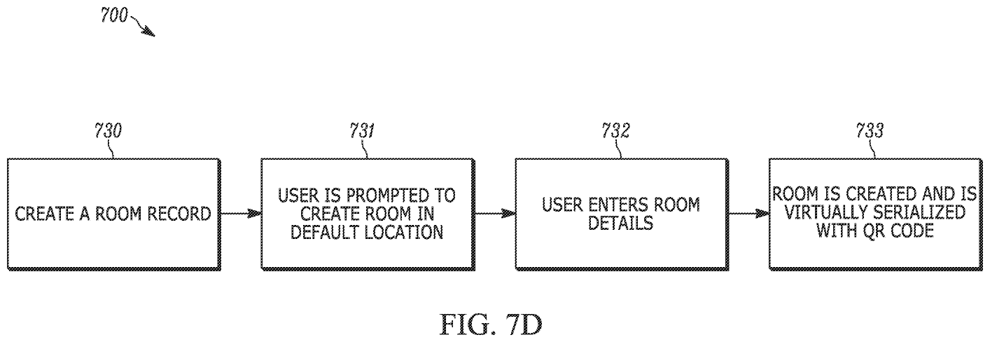

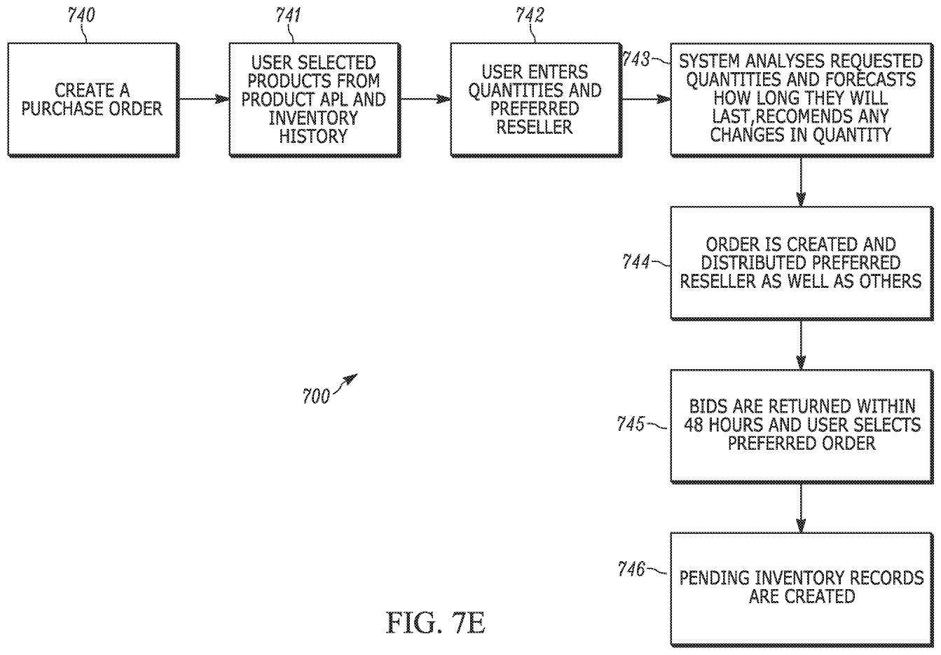

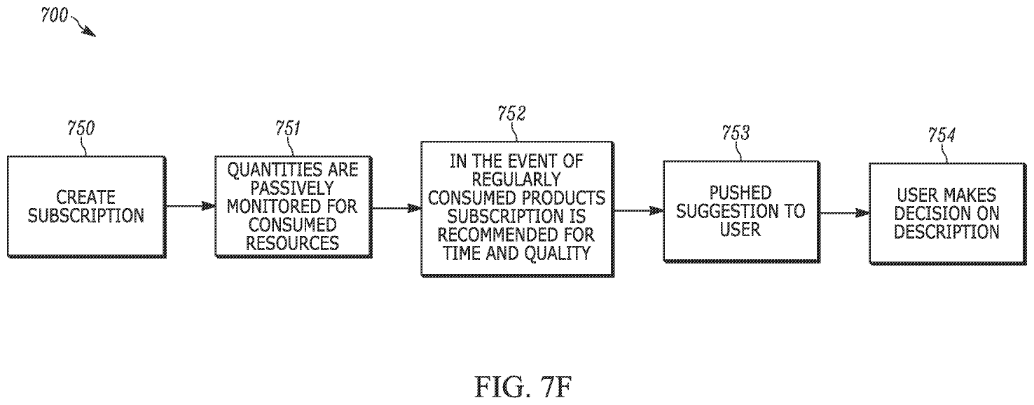

FIGS. 7A-7F illustrate a method and system for managing inventory utilizing the processes of 1A-2B above. First the current inventory of the user, such as an organization or company, must be entered into the system. The system is a cloud hosted asset management application designed to streamline the management of resources, for example IT resources, in a company setting. The system includes applications for handling recording inventory, ordering inventory, deploying inventory, and tracking inventory, such as recording consumption of consumable resources. The system analyzes data over time to augment the resource management plans, such as automatically updating the order subscriptions of consumable products, recommending orders and frequencies, and identifying surplus or stagnant inventory to be resold.

The term “user” is used herein to describe the activities of a person interacting with the system. The “user” need not be an individual, it can instead be a team of individuals each of whom have access to the system. In some forms, multiple members of an organization have access to a shared account with different roles, such as manager, IT employee, and deployable person. Additionally, locations and person assigned to pieces of inventory are tracked and that activity is also managed over time. In some forms, every member of an organization has some access to the system to access and/or edit data with respect to inventory currently assigned to them.

As described in FIG. 7A, product entries are manually created 701. In some forms, the product entries are manually created by entering 702 the relevant data into a form in the system. Alternatively, the product entries are imported from a format understood across multiple operating systems, such as an API. For each product entered, the user enters 703 a quantity of products currently on hand. The system then generates 704 virtual serializations for each individual product. The serializations are unique to the individual units, not just to the type of product. For example, if the user inputs that the current stock includes 20 laptop computers. The system will generate 20 unique virtual serializations to correspond to the 20 individual laptop computers. Each serialization has a corresponding code that can be attached to the unit, such as printed and pasted. For example, barcodes, QR codes, or 3D barcodes can be used, printed out, and then secured to the units. In some forms, RFID stickers are used for the virtual serialization. By these codes, individual units can be scanned, such as by a portable computer or smartphone, and then data on that unit is retrieved from the system. The data can be stored locally on a central computer or in cloud storage.

Use of the virtual serialization is also used by individuals in possession of resources to input and manage requests, such as deployment requests, support requests, or trouble tickets. In one form, an application on a smartphone displays forms for making the requests in connection with a scanned code, the application records the user inputs into the form and then transmits the form to the relevant individual, such as the IT department.

Instead of manually inputting each inventory entry into the system, existing inventory databases can be parsed for the relevant information through the import 710 existing product sheet process shown in FIG. 7B. The parsing is substantially similar to the parsing described above. The user uploads 711 the database file, such as a spreadsheet or comma separate values (“csv”) formatted text file. The system scans the column and row titles, analyzes them, and returns 712 them to the user. The scanned titles are compared to expected titles, such as “name”, “serial number”, “quantity”, “manufacturer”, etc. If the titles are not automatically identified by the system in this comparison, they are displayed to the user who is prompted to input 713 information identifying what the title refers to. Once the columns or rows are connected to corresponding categories in the system, the product and part records are created 714. The import template is stored 714 such that when future documents having the same template are uploaded, the titles can be identified without user input.

Some products might already have individual, unique serialization. If the products have unique serializations, part records are created 715 with the relevant serials. The system uses those serializations and generates 716 codes, such as QR codes, that can be printed and attached to the product based on those serializations. If no individual serializations already exist, virtual serializations are created 717. Then, corresponding codes, such as QR codes, are created 718 which are also printed and attached to the products.

In some forms, the QR codes are not generated and printed/attached until the product leaves inventory. For example, if the inventory has 20 laptops, 20 serializations are created. However, these 20 serializations are not assigned to individual laptops until the laptops are deployed. When the first laptop is deployed, it is assigned the first of the 20 serializations and is marked with the codes, such as a QR code. The other laptops are marked as they are deployed in the same manner. Deployment is described in greater detail in FIG. 7C. To deploy 720, the user selects 721 a product in the system to be deployed. If the product is unmarked, they are prompted to print and attach 722 a code as described above. If the product is already marked 723, such as by the manufacturer or during a past deployment, this step is skipped. The user further selects 724 a target of deployment. The target can be a location or a person. In some forms, the location may be another product, for example a computer component may be deployed to a computer.

The system records 725 the deployment as pending until confirmation is received. If the deployment is to a person, the person is prompted 726, such as via the application or via email to confirm receipt of the product. Once it is confirmed the system update the location of the product. If the product is being deployed to a location, the person doing the deploying confirms 727 deployment. In some forms the individual locations, such as individual rooms, have serialization and corresponding codes, such as QR codes. When a product is deployed, the person doing the deploying can scan the QR code of the room to confirm deployment.

Creation 730 of a location is illustrated in FIG. 7D. The user creates 731 an entry for a room in the system. The user then enters 732 information about the room into a form generated and displayed by the system. The system then creates 733 a virtual serialization with a corresponding code so that the room can be marked.

Turning to FIG. 7E, the system can be used to coordinate with entities outside of the organization for inventory control, such as by creating 740 purchase orders. A user can manually create a purchase order by selecting 741 a product from their API or from their inventory history. The user then enters 742 the quantity to be purchased. In some forms, the user selects a preferred reseller from which to make the purchase. The system analyzes 743 the request and forecasts how long it will take to fulfill the order based on information from the systems and methods of FIGS. 1A-2B above. The order is created 744 and distributed to the preferred reseller as well as other resellers. The resellers return 745 bids within a predetermined amount of time, such as 48 hours, which are displayed to the user so that the decision can be made. In some forms, the decision is automated based on previously input preferences. For example, the order can automatically accept the lowest cost bid that can deliver the product by a predetermined deadline or within a predetermined timeframe. Alternatively or additionally, the system may store a list of previously approved to disapproved resellers. Once the order is processed, pending inventory records are created 746 so that serializations can be assigned once the order is received.

In addition to one-time orders, subscription orders can be created 750 by the system 700 as shown in FIG. 7F. The system passively monitors 751 the rate at which products are re-ordered by the organization. For products that are consumed at regular rates, the system suggests 752 time and quantity for subscription-based purchases. The system finds the best deals for these subscriptions as described in FIGS. 1A-2B above. The recommendation is sent 753 to the user, and the user makes 754 the final decision based on the information sent.

In some forms, the system utilizes the methods of FIGS. 1A-2B to push other types of purchases. For example, when a group buy, sales event, or other similar temporary price reduction is offered by a reseller, the system pushes recommendations for order to the user sooner than it normally would. In some forms, the pushed recommendation includes information representing the projected savings as well as the projected amount of time until the products are needed.

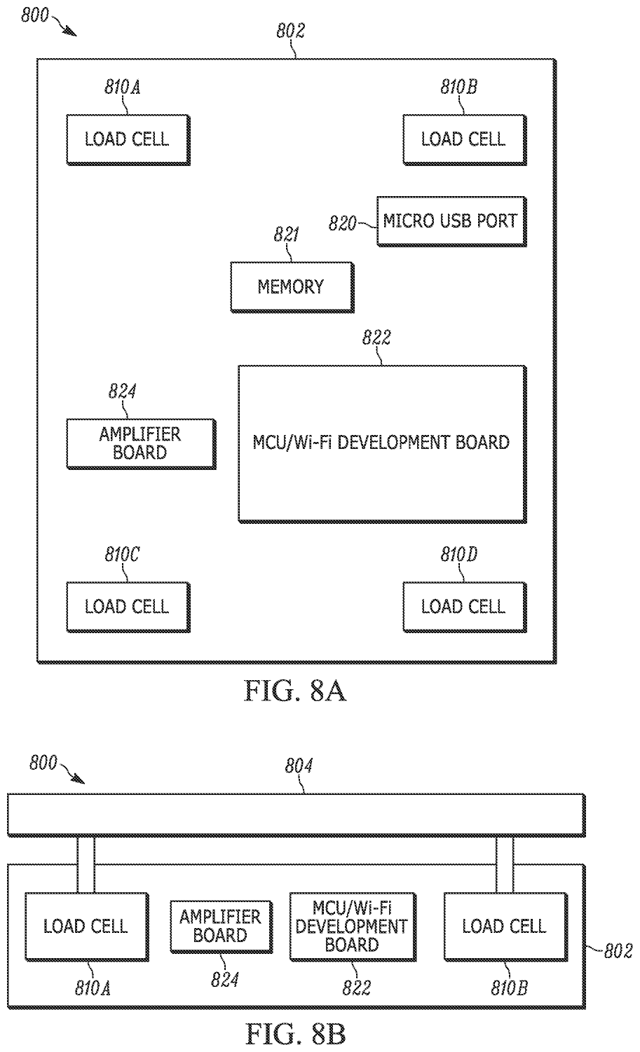

In addition to the scanners described above, some systems utilize additional sensors to automate the tracking of inventory. For example, sensors in the supply room detect the presence of and quantity of products. In one form, scales are used to detect products. For example, tension bar scales built into the shelves. An exemplary shelf 800 with load cells 810A-D for detecting the weight of a product is shown in FIGS. 8A-8B and described below. Alternatively or additionally, conductive plastic is used as a shelf surface, such as Velostate®, to detect the shape and weight of items. The shape and weight are compared to stored values to identify the product and quantity of products.

Below an exemplary use of the system and methods of FIGS. 7A-7F is described. This example is not limiting, it is just to illustrate the system in greater detail by use of an example. While an IT department is used in the example, other departments or organizations can use the system.

### Data Types in the System of FIGS. 7A-7F

Team—The IT staff of an organization or all entities that would be actively managing inventory.
User—Individual member of the IT team, can have limited access to data set and limited capabilities.
Location—A physical address of a business, can have inventory assigned directly, has QR Code.
Room—Belongs to a location, can have inventory assigned to it, either deployed or stored, has QR Code.
Person—A non-user entity that can be assigned inventory i.e. an employee at a company, can have QR Code.
Product—An item that is owned by a company, a type of products, such as a Macbook Pro, would be a product.
Part—The individual manifestations of a product. The three Macbook Pro's on hand would each be a part related to the parent product, has QR Code.
Deployment—The movement of a part to a person, place, or product, has parts assigned to it and destination for those parts, has QR Code.
Order—A user constructed order of products.
Offer—A reseller price response to an order.
Template—A recorded record of connected data types from a product data import.

### Virtual Serialization

The created faux serial numbers attached to parts in inventory for the purpose of tracking deployment and activity related to them. An easier way to serialize and manage individual part records.

### Inventory Deployment to Person

You have 10 laptops in your inventory that aren't currently deployed, a new employee joins the company and needs a laptop. At this point, you've already created the person record in the system.
1) Click create simple deployment and assign a laptop to that deployment.
2) In this particular instance the laptop will travel with the person so rather than assigning it to a room, we just assign it directly to a person record, the new employee
3) The system directs you to retrieve a laptop and print the virtualized ‘serial number’ in the form of a QR code and attach it to the laptop.
4) The deployment status is set to ‘pending.’
5) A) The laptop is delivered to the person who will be using it and they open the QR code scanner on their smart phone and scan the QR code. They confirm their identity and the deployment is closed. B) The user who is delivering the laptop opens the TekCloset Mobile app and scans the QR code and takes a picture of the employee with the laptop, the deployment is marked closed.

### Inventory Deployment to Room

Same scenario as above except in this instance we will be deploying an Apple Cinema Display monitor to the employee's office. This particular piece of inventory shouldn't be going anywhere so we will be deploying it to a room, but also attaching it to a person record.
1) Click create simple deployment and assign the monitor
2) Search either the person or office that the monitor will be deployed in
   A) In the instance that the requisite room has not been created, simply select the person and click the “Deploy to Room box” and a room “New Employee's Office” will be automatically created
   B) If the room has already been assigned to a person the inventory will also be associated with them as well
3) The system will then direct you to either scan an existing QR code on the part or print and attach a new one.
4) The deployment status is set to pending.
5) Once the monitor has been delivered the user scans the QR code on the room and completes the deployment.

FIGS. 8A-B illustrate a shelf unit 800 having a plurality of load cells 810A-D. The shelf unit 800 includes a base 802 and a product support 804. The base 802 houses one or more load cells 810A-D. The product support 804 is supported by the load cells 810A-D such that the weight of the support 804 and supported objects is measured by the load cells 810A-D. In some forms, the load cells 810A-D only measure the total weight of the support 804 and supported products. In alternative forms, data from the array of load cells 810A-D enables the system to approximate the location from which a product was removed, such that the identity of the product can be predicted based on the location and weight.

The shelf unit further includes a MCU/Wi-Fi development board 822 and amplifier board 824 that together transmit a wireless signal conveying the data from the load cells 810A-D. Alternatively or additionally, the shelf unit 800 includes a memory unit 821. The memory unit 821 records and stores data output by the load cells 810A-D. The user can access the stored historical data through an input/output port 820, such as a USB, Mini USB, or Micro USB port.

In operation, the load cells 810A-D output data representing a change in weight of the product support 804 and supported products. The data is transmitted to a computer, such as an onsite computer or a remote server. The computer or server has a processor and a memory unit. The processor compares the measured data to a database, stored on the memory unit, of known values, such as weight and location, or products stored on the product support 804. Through this comparison, the system identifies the product and quantity of products removed. In some forms, instead of a remote computer and local controller with a memory unit and a processor performs the steps described above. As described in the processes above, the system tracks the rate at which products are removed from inventory in order to develop and recommend purchasing plans to replenish the inventory before it reaches zero.

While the shelf unit 800 is shown as a flat, horizontal shelf, it is understood that the shelf unit 800 could be replaced with any type of product support having a weight sensor. For example, weight sensors could be added to an existing counter, bin, cabinet, drawer, or other structure configured to support products. The weight sensors would be communicatively coupled to a processor to operate in the same way described above.

In some forms, the weight sensors are internet of things weight sensors having built in wireless communications modules. The built-in wireless communication modules operate to transmit data representing the measured weight to a remote processor.

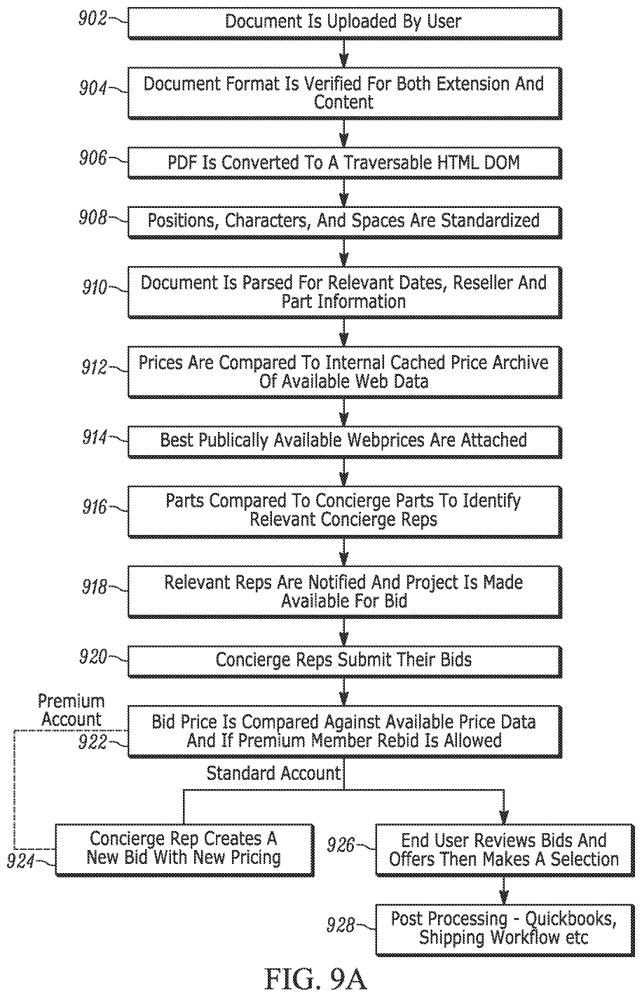

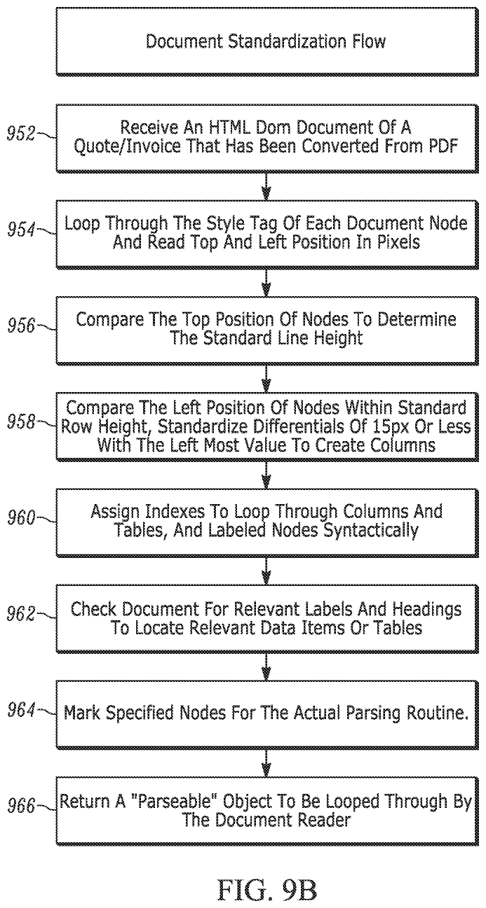

FIG. 9A illustrates a method and system for aiding in consumer purchasing. The method begins with a user uploading 902 a document, such as a shopping list or invoice. The user is an individual or an entity, such as a company or organization. For companies or organizations, a number of authorized individuals (or stakeholders) are identified and able to upload documents to initiate a project. The user has an administrator able to add and remove authorized accounts associated with the user.

The system verifies 904 the content of the document. Verification includes both verifying the format of the document for both extension and content. Once verified, the document is converted 906 to HTML Document Object Model (DOM). The HTML DOM format is readable by the parsing application so that the content of the document can be read by the system. In alternative embodiments, document types other than HTML DOM is used by the parsing application. The HTML DOM document is standardized 908 for spacing, positions, and characters. In some forms, the document is converted to a relational object with coordinate, content, and spacing information and visual artifact indicators such as, for example, table borders or other relevant symbology. The standardization process is described in greater detail below in the discussion of FIG. 9B. After standardization, the document is parsed 910 for relevant information. Relevant information includes part information (such as part number, manufacturer name, model name, etc.), dates of past transaction, dates of future transactions, reseller information, price information, and quantity information.

Once the objects from the list are identified, they are compared 912 to stored prices in the system. The comparison stem 912 compares various publicly listed prices of the specific part from multiple sellers. In addition, the system accesses a database identifying comparable alternative products, such as similar products from the same manufacturer or alternatives made by other manufacturers. The prices of these alternative products are also included in the comparison. In some forms, the alternative products in the database includes house brand products sold by the retailer. In one optional embodiment, the system receives inventory data from various distribution and retail partners and maintains a virtual inventory database including inventory the system is able to offer for sale as described in further detail below. The system may compare 912 the identified objects with the virtual inventory data.

The alternative product database is built out over time. Some products identified by the manufacturers as direct replacements (such as new models or premium models) are automatically uploaded to the database. The system also identifies comparable products that are not directly linked, such as products made by other manufacturers, by analyzing the technical specifications. Products identified in this way are reviewed and approved by a human before being added to the comparable product database in order to ensure that the products are truly comparable.

The system can further form connections between comparable products based on shared connections. For example, if Product A is comparable to Product B, and Product B is comparable to Product C, the system will automatically form the connection that Product A is comparable to Product C. In some forms, these automatically identified connections are reviewed by a human before the database is updated.

In addition to current prices, the system stores caches of prior webpages or prior price information. The cached price information is used to provide a context for the current prices and to identify pricing trends. For example, if the product is currently on sale, the cached price information having the non-sale price is used to determine the amount of savings the sale provides. Additionally, the stored cache sales data can be used to identify seasonal variations in price such that price changes can be anticipated. The system may also store concierge offers (described below) that may also be used as prior price information.

The publicly available prices from the comparison are attached 914 to the project and sent to the user. The prices include a list of current prices and associated sellers for the identified part. In addition, the price list may include the part number, seller information, and prices of the comparable products identified above. This include specifications and/or technical comparisons to illustrate the similarities of the two products so that the user can determine if the alternative product is suited for their needs. Additionally, the available prices will identify any temporary prices, such as sales prices, included in the list along with the sales price expiration date.

In addition to identifying publicly available prices, the system also identifies 916 concierge representatives associated with the listed parts. As discussed above, the concierge representatives are sales representatives associated with either specific sellers, specific users, specific products, or specifics fields of products. Based on the products parsed from the document, one or more concierge reps may be notified 918 and a project is created in the system. The concierge reps may be able to change settings of their account to be notified about some or all opportunities to submit bids for certain products. For instance, the concierge rep may be able to limit the notifications they receive to certain products and/or product categories. The system may notify the concierge representatives of the incumbent prices of the parts on the list, for example, the prices publicly available on one or more websites. The concierge representatives prepare and submit 920 bids on the project. In some forms, the bids include a single price for fulfilling the entire project, i.e., a price for every product on the list. Alternatively, the concierge representatives bid on individual products within the list.

The system compares 922 the bid prices to the publicly available attached in step 914. In some forms, the concierge representatives are notified if their bid price does not beat the publicly available prices such that a concierge representative can rebid 924. In one form, the rebid 924 is only available to concierge representatives who have a higher level or premium account. Alternatively, the rebid step is available to all concierge representatives if the document was uploaded by a user having a premium account.

In some forms, the concierge representatives automate the rebid process. Products have a lowest possible sales price, or price floor, at which the concierge representative is able to sell the product. The automated bidding automatically generates a bid that is the higher of a predetermined percentage below the lowest publicly available price (such as 1%-5% lower) and the price floor.

The bids from the concierge representatives are sent to the user. The end user then reviews the bids along with the publicly available prices and selects 926 a purchase option. In addition to the bid prices, additional information is included. For example, customer reviews of the products and/or the concierge representatives, historical pricing (for example, prices over the past 30 days, 60 days, and/or 90 days), and technical descriptions of the identified comparable products.

Once an option is selected, the system sends the purchase order to the seller and the sale is made. In addition, the system automatically generates an invoice or receipt. In some forms, the automatically generated invoice is of a format readable by bookkeeping software, such as Quickbooks such that the sale is automatically loaded into the software.

In some embodiments, the user provides information in addition to the standard part number, quantity, and price information. Potential information may include budget information, product usage rate information, historical purchase and usage information, and/or projected future usage information. This additional information is used by the system and/or the concierge representatives to more narrowly tailor recommendations to the user. For example, budget information can be used to recommend alternative products in order to meet a budget that would otherwise be exceeded. Alternatively, if room remains in the budget, additional purchases of non-perishable products is recommended in order for the user to build an inventory of products that will be needed later. The future use information, or future use needs extrapolated from the historical use information, is used to recommend purchases before needed during sales or low price periods in order to save money.

In addition to being used to facilitate sales, the above identified system can be used to generate retroactive price savings reports. The user uploads invoices from past purchases. The invoices are parsed for the product information, price information, and invoice date. The invoice prices are compared to the cached historical prices and/or current prices to identify instances in which the user overpaid compared to the prices available through the system.

FIG. 9B illustrates a method for standardizing a document, such as occurs in step 908 above. The standardization software receives 952 a document, such as the HTML DOM document generated above, of a quote or invoice that has been converted from a different file format. The system loops through 954 the style tag of each document node and reads the top and left position in pixels. The top and left pixels are used to identify where the entry begins. The system may also identify and use borders or other visual artifacts of the document to group data together. The top position of the nodes is compared 956 to determine the standard line height so that the different lines of data can be more easily identified and parsed. The left position of the nodes is compared 958. Small differences, such as differentials of 15px or less are standardized with the left most value to create a standardized column. Larger differentials identify a difference in columns.

In step 960, indexes are assigned to loop through columns and tables and labeled nodes syntactically. Next, the document is checked 962 for relevant labels and headings in order to locate relevant data items or tables. For example, labels or headings may identify specific types of data contained in the column or table, such as prices, quantity, part number, etc.

Based on the above steps, the system marks 964 specified nodes for the parsing routine to parse. The parseable object, e.g., the standardized document, is returned 966 to the document reader software to be parsed.

As discussed above, the comparable products include house brand products of the seller or marketplace. In some forms, the price of the house brand is automatically generated based on the prices of the other products. The price of the house brand is set at the higher of a predetermined lowest possible price, and a predetermined percentage below the lowest cost of the non-house brand alternatives (for example 1%-10% lower). In one form, the house brand is set 5% below the lowest price alternative so long as that is equal to or greater than the lowest possible price for the product.

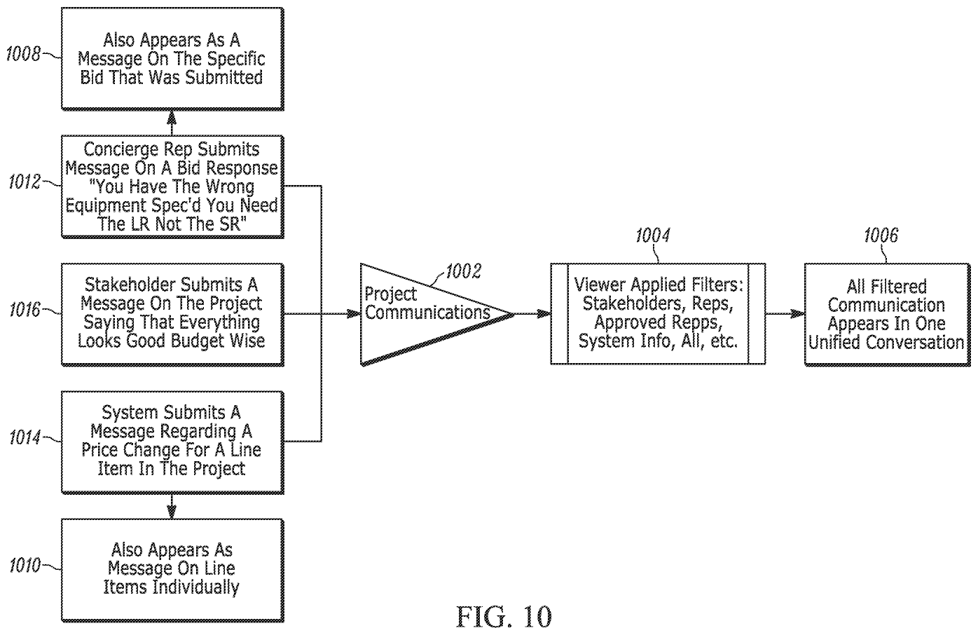

A number of messages are generated with respect to the projects discussed above. FIG. 10 illustrates a system and method for facilitating messages across multiple channels to be more easily located by the users. A project communications 1002 database stores all of the communications associated with a specific project or users. The database includes a number of tags 1004, such as the stakeholder, the concierge representative, the approved reps, the products, etc. that are used to filter the communications. When the filters are applied, the filtered communications are viewable as a single unified conversation 906.

In addition to the central project communications database 1002, specific types of messages appear at other locations within the project. For example, a message 1012 submitted by a concierge representative about a specific bid, such as a message relating to the specific products identified in the document, alternative products, or prices, appears as a message on the specific bid 1008. In another example, a message 1014 automatically generated by the system relating to a price change on a product appears as a message on line items 1010 individually. Other messages, such as a stakeholder submitted message 1016 affirming that the project is within the budget only appear within the project communications database 1002. The database 1002 preserves a record that can be referenced later by the user to ensure that certain steps were taken, such as the stakeholder confirming that the budget was met.

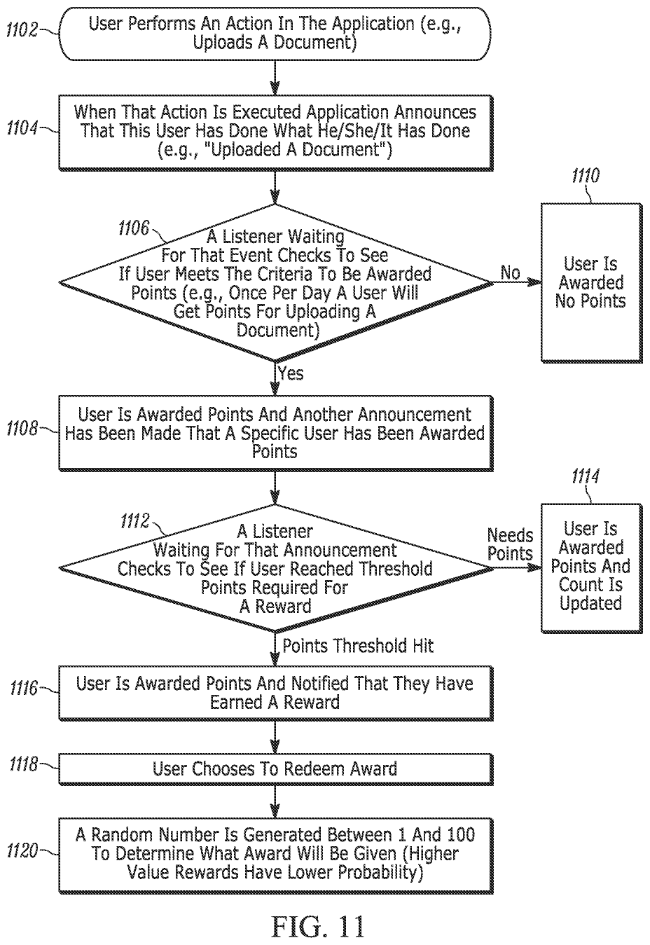

FIG. 11 illustrates a rewards system and method for use with the systems described above. The awards are randomized, providing users an opportunity to win rewards more valuable than would otherwise be available in a nonrandomized system. In order to qualify for awards, the user must first take part in the above system, such as by uploading 1102 a document.

The system generates 1104 an alert indicating that the action 1102 was taken. The system includes a listener which receives the alert and checks 1106 to see if the action meets the predetermined criteria for being awarded points under the reward system. For example, the criteria requires that a document to be uploaded on a certain date and the listener compares the upload date to the required date. If the action 1102 meets the criteria, the user is awarded 1108 one or more points and announcement indicating that points have been awarded is generated. If the action 1102 did not meet the criteria, the user is not awarded 1110 points.

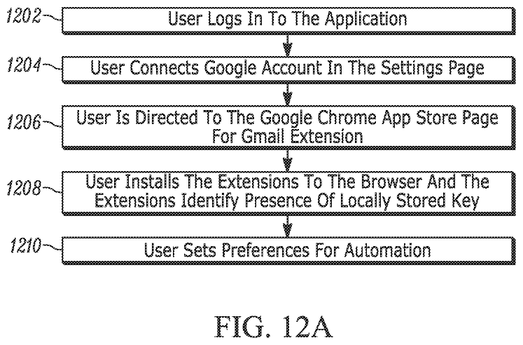

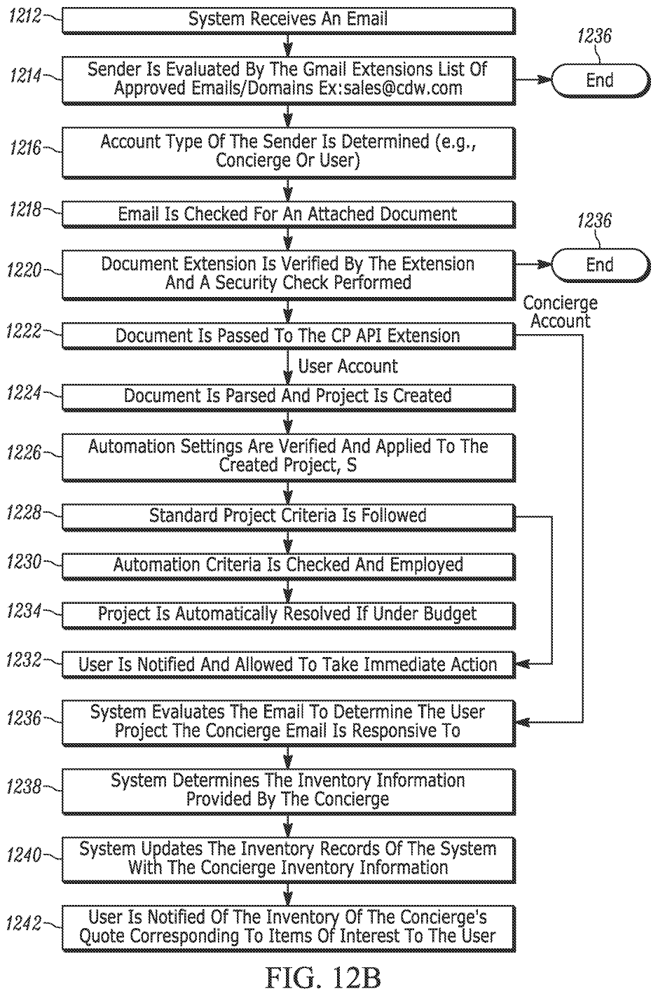

A listener receives the point alert and compares 1112 the total points awarded to the user to a stored threshold required to qualify for rewards. If the user does not yet meet the threshold, the user is awarded points and the count is updated 1114. If the user does meet the threshold the user is awarded the points and a notification is sent 1116 to the user indicated that the threshold is met. After receiving the threshold, the user chooses to redeem 1118 the awarded points. The system randomly selects 1120 one of the available rewards when the awarded points are redeemed. In one form, the random selection involves using a random number generator and comparing the generated number to an index of rewards and corresponding values. The rewards vary in value. For example, multiple rewards may offer a discount of different amounts, such as a 1%-15% discount. In some forms, the higher value rewards are less likely to be selected than the less valuable rewards. In some embodiments, all of the rewards relate to savings on future purchases, such as discounts or free shipping offers. The rewards must be activated within a certain time frame after redemption, such as within 30 days or 60 days. Once activated, the rewards are only active for a certain number of purchases or amount of time, such as 24 hours or 1 order. In alternative forms, other rewards are possible. For example, rewards may include free products as prizes. In some embodiments, when a relevant action 1102 is performed by a user, the system calls an external service with the name of the event or action that occurred. The event or action is then compared to a database of events and values at the external service to check 1106 whether to award points to the user and whether a reward is to be given. The external service then broadcasts the award value back to the plugin of the system. The above-described systems include the step of a user uploading a document. In some forms, this is done through an interface such as a webpage or application. In alternative forms, the systems are interfaceless. FIGS. 12A-12B illustrate an interfaceless method and system for interacting with the systems and methods described above.

The interfaceless system involves installing an extension or application that runs in the background to identify documents, such as email attachments, to be uploaded into the purchasing systems described above. FIG. 12A illustrates an exemplary set up process utilizing a Google Chrome extension. It is understood that extensions for other browsers or background applications for tablets, smartphones, or computers can also be used for the interfaceless system. In some forms, the user first logs in to 1202 the purchasing application. Within the application, the user connects 1204 the application account to a google account (or other account associated with the preferred browser or operating system) The user is linked 1206 to an application store where the extension or application for interfaceless use is downloaded for installation. The user installs 1208 the extension or application. In some forms, the extension or application identifies a locally stored key to authenticate the extension or application and connect the extension or application to the user's account with the purchasing application. In some forms, the user need not first log in to the purchasing application but instead the user may install 1208 the extension directly from the extension or application store. The user may then be prompted to register for a new account or to sign in to an existing account to receive the functionality of the extension.

Once installed, the user sets 1210 the preferences within the extension or application. The user may choose what sites the extension will function on or opt to have the extension function on all sites. The preferences include a number of settings for automating the uploading process. For example, the settings identify where the application or extension monitors for documents or data to be uploaded. Potential options include email bodies, email attachments, online shopping carts, bookkeeping software, and inventory monitoring software. If emails and/or attachments are monitored, the user can identify specific sender/recipient addresses or specific email domains that are monitored. Identifying specific addresses or domains prevents the application from monitoring the contents of other emails. Preferences further include payment options and purchase verification requirements.

FIG. 12B illustrates a process followed by the interfaceless application or extension. The process of FIG. 12B is an exemplary application or extension which monitors received emails for attachments. It is understood that the process of FIG. 12B is similar to processes used to monitor things other than received email attachments as described above.

The system receives 1212 an email. The application evaluates 1214 the sender information of the received email to determine if it is a sender address or domain listed in the preferences to be monitored. The application may compare the sender email address with a database of approved email addresses and/or domains. If the sender is not listed, the process ends 1236. If the sender is approved 1216, the account type of the sender is determined (e.g., concierge or user) and the email is checked 1218 for attachments. The extension of the attachment is verified 1220 as a file type readable by the system and checked for malicious code, attachments, viruses, and the like. If the extension of the attachment indicates that it cannot be read by the system, the process ends 1236.

If the document does have a readable extension, the document is passed 1222 to the purchasing system. As discussed above, the purchasing system parses the document and, where the sender has a user account type, the system creates a project 1224. The automation setting selected in the preferences are verified and applied 1226. With the settings applied, the standard project criteria is followed 1228 as described in the methods above. If the process is not automated, the user is notified 1232 once the project is formed in order to complete the purchase. If the process is automated, the automation criteria is employed 1230. The system compares the purchase price to the stored budget, if the project is under budget, the purchase is automatically resolved 1234.

Where the sender has a concierge account type, the system evaluates 1236 the email to determine which project the email of the concierge is in response to. The system further may determine whether the prices of the concierge's quote should be made available across the application or just to the user to which the concierge is providing a response to. The system parses the response document received in the email of the concierge to determine 1238 the inventory information provided by the concierge. The system updates 1240 the inventory records of the system (e.g., the virtual inventory database) with the prices for the parts identified in the response document of the concierge if the parts/prices are to be made available across the application. Upon parsing the concierge's response document and determining that the concierge's quote includes a comparable item to a part in the users' project, the user is notified 1242 of the concierge's quote. Other user's searching for products listed in the concierge's quote may also be notified that new prices are available where applicable. The above-described systems relate to ecommerce. The prices and sellers discussed sell products over the internet and ship them to the user. In some forms, the system receives inventory and price data from stores. Based on the location of the user, local businesses are recommended to make in person purchases as an alternative to the provided ecommerce options. The system sends the purchase information to the local store so that the product is ready to be picked up by the options. The system charges a per transaction or percentage rate on top of the price charged by the store. In one form, the system charges $1 per transaction for the local buy option.

This system provides local businesses with the opportunity to compete with ecommerce retailers and capture business that otherwise would have been lost to the ecommerce website. This system also provides shoppers with the opportunity to compare the prices of products offered through the ecommerce website with local product offerings. Shoppers are also presented with the opportunity to consider their local businesses and support their local economy.

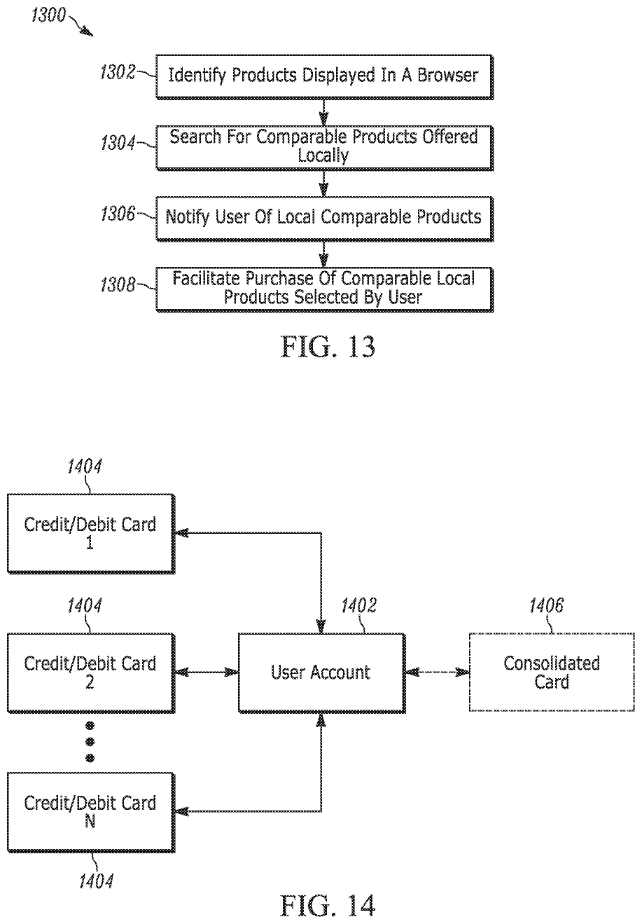

This system may be a web browser extension that notifies the user when a product displayed within the web browser may be purchased locally according to method 1300 shown in FIG. 13. In another approach, the system may be a program or smartphone application that runs when a user is shopping on a web browser application or other smartphone application, such as an application associated with an online retailer. The system may identify 1302 the products displayed via the web browser to the user. The system may identify the products displayed be deploying a content script (Javascript) onto the webpage. The script may be configured to scan or look for indicators of a purchasable product such as, for example, a “buy” or “add to cart” button, price information, and/or a manufacturer part number. The system, upon determining the location of the user, may create a list of all local businesses within a certain radius of the user (e.g., 15 miles) from which it searches or crawls 1304 for comparable products. Alternatively or additionally, the system may compare the identified product with products in the product database or virtual inventory of the system. Where the system identified a manufacturer part number form the website, the system may search the virtual inventory of the system using the manufacturer part number. Where no results are found using the manufacturer part number or if such number is not available, the system may perform a search use the product descriptions and titles to return a fuzzy match with the items in the virtual inventory. A minimum correspondence between the product description and titles of the website and the virtual inventory listing may be required for a match to be found, for example, at least a 90% correspondence. The system may also add the scraped product data of the website to the virtual inventory database of the system.

In some embodiments, the system may pass the items of interest to the user (e.g., the items the user is viewing on the website) to its product suppliers and/or concierge representatives. The product suppliers and concierge representatives then have an opportunity to provide pricing for these identified items of interest to the user and may submit a quote for the same. The system may present these quotes to the user via the web browser extension as described above.

Upon identifying a comparable product offered for sale locally, the system may notify 1306 the user that a local business is selling the same or a comparable product. In one form where the user is shopping on an ecommerce website, the system may display or notify the user of a local business that offers the same or similar products to those displayed by the ecommerce website to the user. As an example, the system may display a notification, window, or pop up next to each product listed on the ecommerce website where a comparable product is available locally. The notification, window, or pop up may display the name, a picture, and/or the price of the local item and/or the name of the local business offering the product for sale to the user. In another example, the system may simply display text or an icon associated with the web browser extension that indicates a local business offers a comparable product. For example, the system may display “Buy this Product Locally!” or similar text along with a selectable link to the comparable local product offering.

In some forms, whether the product is available from a local seller is one factor used by the system in determining which comparable products to present to the user for consideration. Another factor may be the price of the comparable products. A user may adjust the settings of the browser extension to adjust which comparable products are presented and/or the order in which the products are displayed to the user. For instance, the user may select to have the system present the lowest priced item first, to have the system show the item at the store closest to the user first, or to have the system determine the relevance of each item based on a combination of these parameters (e.g., where two items are listed at the same price, to show the most local item first).

In another form, the system displays or indicates that local options are available when the user goes to a checkout page of the ecommerce site or application. The system may display a notification, window, pop up, text, and/or an icon to the user that indicates that local options are available for products the user has selected to purchase from the ecommerce website. In one example, the system may cause a window to pop up on the user's display screen that indicates that one or more of the products selected for purchase have a comparable option available at a local business.

The system may then facilitate 1308 the purchase of the comparable local products displayed to the user. The user may select a button or link displayed in the window to purchase one or more products from the local business(es). In one example, the user may complete the purchase of one or more products from the local business(es) through the system in a popup window. For instance, when the user elects to proceed with the purchase of an item, the system collects the funds from the user (e.g., collects the payment information), creates a purchase order for the item and facilitates ordering the purchase and fulfillment of the item with the seller on the backend. In another example, the user may be brought to another website to complete their order of the products through the local business(es). The system may place the order with the one or more local businesses through the website. The local business(es) may be notified of the user's order and prepare the product for pickup by the user. Alternatively, local business may ship the product to the user, so that the product is delivered to the user, just as it would have been had they completed their order through the ecommerce website or application. In another example, the system may provide links to the websites of the local businesses through which the user may complete their purchase of the comparable products. In yet another example, the system may display that the comparable product is in stock at a local business, prompting the user to purchase the product at the local business.

Local businesses may provide product and pricing information to the system via processes the local businesses already have in place for their own e-commerce sites. For example, the local business may provide their product and pricing information to the system via QuickBooks inventory or CSV files that are used to manage inventory at their local stores.

While the above description relates to using the system to promote purchase of goods from local stores, in other forms, the user may change the parameters of the system to not be limited to presenting the user with items from local stores or those within a certain distance from the user. The system may be configured or configurable to present users with comparable products that have lower prices regardless of the location of the seller. The system may be reconfigurable by the user, for example, the system may provide the user with adjustable parameters or filters that the system uses when searching for and identifying comparable goods to offer to the user. When the user simply wants to be presented with comparable goods that are priced lower than the items they are viewing on a website, the system does not limit its search to local businesses or those within a certain distance from the user but instead searches or crawls the internet and store websites regardless of the location of the physical store. Stores, sellers, and suppliers may send the system a list of inventory (e.g., a spreadsheet listing all goods available) which the system may use to search for comparable goods. The system may compile all of the inventory from the various stores, sellers, supplies and the like into a product database or virtual inventory and search the database for the comparable goods to present to the user. Upon identifying comparable goods, the system may present the comparable goods to the user as described above.

In another aspect, an automated savings system is disclosed that may be used to consolidate a user's credit/debit cards such that when a user makes a purchase the system applies or recommends the use of the credit/debit card that will achieve the greatest amount of rewards points, discount, and/or cashback for the user. This system obviates the need for a user to think about the promotions and offers of each of their cards to determine which card will provide them with the best deal. The system automatically determines the best card to use for the purchase based on the standard rewards of the card and the current promotions/offers associated with each card. In one form, the user provides the name of the business, restaurant, or item they wish to purchase to the system and the system displays the card the user should use to achieve the greatest savings and/or benefit. In another form, the system includes or acts like a credit/debit card that the user uses to complete a purchase. On the backend, the system completes the purchase using the credit/debit card it identifies as providing the greatest savings and/or benefit to the user based on the user's cards associated with the system. Using the system, a user no longer needs to think about which card to use since a single card may be used which maximizes the benefit to the user.

The system may be or include a user device running a mobile application, such as a smartphone app. A user may download the app onto their smartphone or tablet. With reference to FIG. 14, the app may prompt the user to create a user account 1402. The app prompts the user to link or associate all of their credit/debit cards 1404 and rewards cards to the application. In one form, a user manually enters the card information into the app. The credit card information may include the credit/debit card provider, the card type, the name on the credit card, the credit card number, and/or card verification value (CVV). The cards may also be linked by uploading photos of the cards to the application. The app may include a feature, such as an icon within the app, that a user selects to take a photo of their card within the app. The app may prompt the user to capture a photo of the front and/or back of each card they wish to associate with the app. The system then processes the image and automatically links each card to the user's account associated with the system. The cards may also be linked to the app by choosing the card from a list displayed to the user within the app. For example, the app may first provide a list of credit/debit card providers to a user. Upon selection of a credit card provider, the app may then provide a list of cards offered by the selected credit card provider for a user to select.

The system may also be or include a web browser extension that the user installs to their web browser, such as a Google Chrome extension. A user may associate their credit/debit cards with the browser extension in a similar manner to that described above in regard to the smartphone app. In another approach, a user may enter account information, such as a username and password, of the user's account they previously setup on their smartphone app or via a website associated with the system. The browser extension may retrieve and display the user's cards that had previously been associated with their user account. Similarly, a user may setup their user account and associate credit/debit cards using the web browser extension and login to their user account via the smartphone app.

In some embodiments, the system includes a consolidated card 1406 that is associated with their user account. The consolidated card 1406 is associated with the credit/debit cards the user associated with their user account. The consolidated card 1406 may be used in place of any of the credit/debit cards 1404, with the system selecting which of the credit/debit cards 1404 will charged based on its analysis of which card provides the best rewards and/or benefits to the user for the transaction. The consolidated card 1406 may be a physical card may be used as a credit/debit card to make purchases. The system, upon receiving notification that a purchase has been made via the physical card, may correspond with the business with which the purchase was made and/or the credit/debit card provider to complete the purchase transaction using a credit/debit card associated with the user account. The physical card may include a cardholder name and card number that may be entered to complete online transactions.

Additionally and/or alternatively, the consolidated card 1406 may be or include a virtual card that operates via a smartphone app of the system to complete purchases via contactless technologies, for example, near field communication (NFC). Upon making a purchase via the virtual card, the system may complete the purchase using the credit card information of a card associated with the user account. In another form, the system determines the business the user is making a purchase at, determines the best card associated with the user account for completing the purchase and achieving the most savings/benefits for the user, and completes the purchasing using that card's information. The system may determine the business the user is making a purchase at by geolocation, manual entry of the business by the user, and/or communication with the card reader of the business as examples. The system may determine the location of the user based on the location of their smartphone using GPS, Cell ID positioning, and/or a Wi-Fi network a user is connected to.

In embodiments where the system includes a consolidated card 1406, the consolidated card 1406 may be an actual credit/debit card through which a user may complete purchases without the association of another card. The consolidated card 1406 may include its own rewards, discounts, and/cashback offers that it provides to users and takes into consideration when selecting the best card to complete the transaction through. The consolidated card 1406 may be added to virtual wallets such as Apple Pay, Samsung Pay, Google Pay and used to complete purchases. The consolidated card 1406 may further be linked to a user's blockchain wallet and enable the user to complete a transaction via one or more cryptocurrencies such as, for example, Bitcoin, Litecoin, Ethereum, Binance Coin, Cardano, Tether, Dogecoin, XRP, etc.

In use without the consolidated card 1406, the system may recommend which card a user should use to receive the greatest benefit. A user may enter the name of a store, restaurant, business, or item into a search tool of the system. This search may be entered via a user interface of the smartphone application, website, or browser extension of the system. The search may be communicated to a server computer of the system for processing. The system may search the rewards and/or promotional offers for the entered search terms that are associated with each of the cards the user associated with their user account. For example, if the user is purchasing gasoline and a credit card of the user earns 5% cashback on gasoline purchases, the system may recommend the user use that credit card to complete the purchase. As another example where the user is purchasing items from a big box retailer, the system may determine that one or more of the user's cards offer an additional discount on goods purchased during that month and recommend the user complete the purchase using that card.

In one illustrative embodiment, a user may enter a search into the system for a place to make a purchase. For example, the user may enter a search for gasoline into a search tool of the smartphone application. The system may process the search request, for example at a server computer associated with the smartphone application and/or browser extension and may determine which gas stations are nearby and whether any of the user's cards receive a discount or rewards to nearby gas stations. The system may then recommend purchasing gasoline from the gas station that provides the greatest savings/benefits to the user factoring in all card-based benefits. In another form, the system may display the price per gallon at each gas station factoring in all discounts the user will receive by use of a card associated with their user account. If no special promotions are offered, the system may recommend completing the purchase using the credit card that provides the greatest amount of cashback or rewards. Alternatively, a user may select a default card to use when no promotions or offers are available.

In another example, the user may enter a search for “food” or “clothing” into the search tool. The system may return a list of nearby locations with promotions or discounts associated with the cards of the user. In another form, the search is not limited by location but provides a list of restaurants or clothing stores with promotions or discounts for the cards associated with the user's account. The user may then decide to travel to the business to complete the purchase or may complete the purchase online. The system may allow the user to complete the purchase through the smartphone application. In another example, the system provides a link to the website or smartphone application associated with the selected business through which a user may complete a purchase using the card that receives the promotion, discount, and/or rewards.

In another aspect, the system may monitor the user's shopping activity and compare the user's shopping activity with the incentives of the cards the user has associated with their user account 1402. Based on the user's shopping activity or history data and the card incentives, the system may be able to notify the user of certain rewards or incentives the user could be taking advantage of for certain shopping activities. The system could thus provide the user with recommendations for future purchases (e.g., which card to use) to maximize the benefit to the user based on the cards the user has.

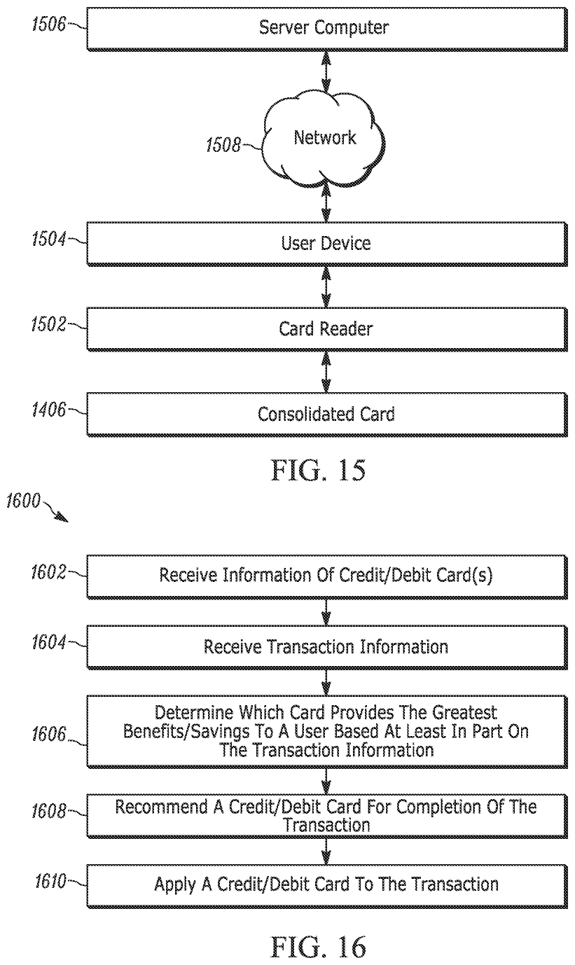

With reference to FIG. 15, in use where a user is using the consolidated card 1406 to complete the purchase transaction, the system completes the purchase for the user on the backend without the user having to search or select which card to use. When using a physical consolidated card 1406, the user swipes, enters, taps, brings near to, or otherwise causes the physical consolidated card 1406 to interact with the card reader 1502. When using a virtual consolidated card 1406, the user uses the virtual consolidated card 1406 by using the NFC features of their user device 1504 running the smartphone application of the system to interact with the card reader 1502. The system then substitutes the provided payment information with the credit card information of the credit/debit card that provides the greatest discount, rewards, and/or cashback for the user. In the example where the user uses the virtual card on their user device 1504 to complete the transaction, the system may provide the credit/debit card information to the card reader of the desired credit/debit card to complete the purchase. This may be complete by communicating with a remote server computer 1506 via a network 1508 such as a cellular network and/or the internet as examples. The server computer 1506 may be a server computer associated with the smartphone application of the system. The server computer 1506 may determine which credit/debit card of the credit/debit cards 1404 provide the greatest benefit to the user and communicate to the user device 1504 to use that credit/debit card to complete the purchase.

In examples where a physical card is used, the physical card provides the card reader 1502 with the credit card information of the physical card to complete the purchase. After the purchase transaction is complete, the server computer 1506 may receive a communication indicating that the physical card was used to complete a purchase. The system, operating at the server computer 1506, may communicate with the credit/debit card provider of the desired credit/debit card to substitute the desired credit/debit card's payment information. For example, the system may bill the desired credit/debit card and/or pass along the purchase details (e.g., the time of purchase, the location of the purchase, the business, the items purchased, the amount, etc.) to the credit/debit card provider. The user may then receive the savings and/or benefits via that credit/debit card.

In one embodiment where a user is purchasing multiple items, the system may determine that one or more items qualify for a discounts or promotion using one card, while other cards benefit from the user of a different card associated with the user's account. The system may automatically divide the purchase into two or more transactions to apply the discounts/promotions of each card in the purchase of each item. For example, if the user purchases gasoline and a snack at a gas station and a card offers 5% cashback on gasoline purchases, the system may purchase the gasoline using the card offering 5% cashback and the snack using the card the provides the greatest rewards/benefits with no promotions available. When making a purchase online, the browser extension may search the internet for additional promotional codes for the user to enter before completing the purchase. In another embodiment, when a user is making a purchase online, the system may provide or promote comparable products that may be purchased locally as discussed in relation to FIG. 13.

The system may also allow a user to select which cards to recommend or to use when no promotions are available based on the user's preferences. For example, a user may select within the smartphone app that they would like to receive as much cashback as possible. When the system is determining which card to apply to complete the purchase, the system will recommend or use the card the achieves the most cashback unless other promotions or discounts provide the user with a better deal. As other examples, the user may opt to receive sky miles, rebates/discounts to big box stores. The user may also select to use a certain card as the default when no special promotions or discounts available.

While businesses such as stores and restaurants have often been used as an example in this disclosure, cities, states and/or countries may also provide promotions and offers to users through the system. As an example, cities may incentivize travel to their city or community by providing credits or rebates upon making certain purchases within the city. For example, a city may offer to credit each traveler $50 if they eat at five restaurants within the city limits. As another example, the city may credit a traveler a percentage of the city tax spent during their time within the city.

With reference to FIG. 16, a method 1600 is provided for providing users with a recommendation of which credit/debit card to use or applying a credit/debit card to a transaction that results in the greatest benefit to the user. The system receives 1602 credit/debit card information via a user device. The user device may be a personal computer, tablet, smart speaker, smartphone etc. The system may receive the credit/debit card information by a user submitting a photo of their card, selecting a card from those displayed to the user, receiving audio of a user speaking into a microphone, and/or manually entering the credit/debit card information into the user device. The system then receives 1604 the transaction information. The transaction information may include the time of purchase, the location of the purchase, the business the transaction was made with, the items purchased, the amount, etc. The system may receive the information from the user entering the information into an application or a search tool of the application. The system may also receive the information from the business or credit card processing company once the consolidated card 1406 has been used to complete the transaction. The system then determines 1606 which of the user's credit/debit cards received from the user provide the greatest rewards, cashback, rebate, discount, benefit, points, miles, etc. based at least in part on the transaction information. This determination may include analyzing the information provided by the card providers regarding their card's rewards program, current promotions, and current discounts. Once a determination has been made, the system may recommend 1608 a credit/debit card for the user to apply to the transaction based on the determination. A user may then use the recommended card to complete the transaction. Alternatively, the system may prompt a user to confirm they would like to proceed using the recommended card. The system may then apply 1610 the recommended card to the transaction. The system may do this by providing the information of the recommended credit card to the card reader, for example, via NFC. Alternatively, where the consolidated card 1406 was used, the system corresponds with the credit card processing company and/or the card provider of the recommended credit/debit card to pass the transaction through the recommended credit/debit card.

Turning now to the smartphone application discussed above, the smartphone application may include a display including home page, a map page, promotion/offers page, a search page, a purchasing page, and/or a rewards page as examples. The home page may display each of the cards a user has associated with their account. The home page may also display one or more promotional offers to the user. The map page may provide an in-application map to the user that shows the offers available at each store displayed on the map. The map may automatically display the portion of the map where the user is physically located at to promote the offers of the nearby restaurants, stores, and businesses. The promotions/offers page may provide a list offers and promotions available to the user based on the cards they have associated with their account. The offers and promotions may be listed according to the best deals, biggest discounts, biggest savings, popularity among other users of the app, etc.

The search page may provide a search bar that a user may enter search terms into as described above. For example, if a user desires to purchase clothing, the user may enter “clothing” into the search bar. The application may return one or more clothing stores to the user through which the user may shop for clothing items. The stores displayed to the user may be based on the location of the user to the stores. Alternatively, the stores displayed may be displayed to a user based on promotions or offers available at clothing stores. A user may also enter the name of a business into the search bar to search for promotions or offers available at that business. Promotions and offers displayed to the user may include first time shopper discounts, student discounts, and the like.

The purchasing page may display a default card that will be used for making purchases when a promotion or discount is not available. The purchasing page may display an image of the physical or virtual card provided to a user to make all purchases with before the system completes the transaction through the desired card. The purchasing page may include a link to a webpage associated with the system of FIG. 13 that a user may use to make local purchases to support their local economy.

The rewards page may include a list of all rewards accounts and cards a user associates with their account. For example, a user may associate a rewards card or account they have with a restaurant. Each time the user makes a purchase from that restaurant using the smartphone app or the physical/virtual card of the system, the system automatically provides the rewards card when making purchase. Thus, a user no longer needs to remember to swipe or scan their rewards card once their card is associated with their user account.

A user may receive notifications via their smartphone app or emails of new offers, discounts, or promotions offered by businesses. In one example, the user receives notifications of these offers based on their location. If a user travels to a new location, the user may receive a notification listing the offers and promotions within that area. The offers and promotions pushed to users may be based on their recent purchases and/or searches. For example, if a user frequently shops for clothing items, the system will notify or email the user of offers or promotions relating to clothing items are available.

The system may also provide the user with a savings summary periodically based on how much the system has saved them. For example, the system may provide a savings report to the user each week, month, and/or year. The savings report may include a graph that indicates to the user how much they spent versus how much they would have spent. The savings report may display a total amount saved using the system.

The system may generate revenue based on the advertisements and promotions that stores, restaurants, and businesses provide to be displayed to users within the application. The businesses may be required to select physical regions where they wish their advertisements to be promoted to users. Businesses may be charged a greater amount to increase the size of the region to which their advertisements are displayed. Businesses may also pay an additional fee to have their name or their advertisements displayed or promoted to users with a greater frequency.

Businesses may also pay a fee to the system each time a purchase is made using the system. For example, the businesses may be required to pay a fee of 1% of the transaction price when a purchase is made using the system or the physical/virtual card associated therewith. Businesses may have their own accounts on the system through which they upload their discounts, promotions, and advertisements. The regions to which a business's offers are displayed along with the frequency of the advertisements may be selected or set via the user account. Businesses may also pay for the display of their offers to users via their user account.

In yet other embodiments, users may associate one or more bank accounts with the system. Users may then select to transfer money from a bank account to another bank account via web browser or smartphone application interface of the system. Users may also send money to other users to pay for items or services digitally. In yet other embodiments, the system provides a platform or page through which a user may purchase and trade stock.

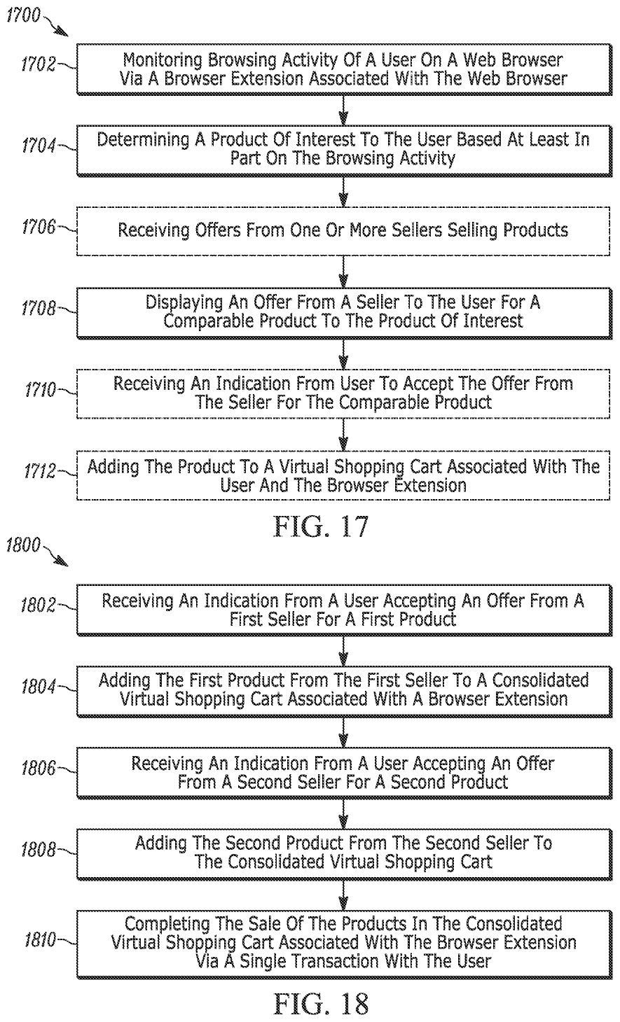

In another aspect, a system is disclosed that provides an online shopper or user with offers to purchase items that the user is browsing or has recently browsed on any webpage on the internet. For instance, the system may provide the user with items at a lower price than those viewed by the user on the webpage. The system includes a browser extension on a web browser that monitors the users browsing activity and offers the user comparable products at lower prices according to method 1700 of FIG. 17. A user installs the web browser extension of the system on their web browser, for example, Google Chrome or Microsoft Edge. The system monitors 1702 the user's browsing activity whenever they use their web browser. The system determines whether the user is shopping for items. For example, the system may do this by monitoring the webpage on which the user is browsing. If the web page the user is browsing is an online store or ecommerce site (e.g., Amazon.com or Walmart.com), look for characteristic items of such a store/site (e.g., look for a shopping cart, look for prices being displayed or items being offered, look for a form of payment or buy now type data, etc.), and/or the system may begin monitoring the items being viewed by the user. The system may also determine that the user is shopping when one or more products are displayed on the webpage to the user along with a price or prices being displayed therewith.

Upon determining the user is shopping, the system may be configured to automatically parse or determine the product displayed to the user and the associated price. As one example, the system may perform optical character recognition (OCR) to determine the type of product and the price. In one form, as soon as the system determines one or more products are being displayed to the user on a webpage, the system may determine whether the system has received offers to sell products that are comparable to those displayed on the users' web page. A comparable product may be the exact same product or may be a similar product offered by the same company or a competitor. In other forms, the system may determine whether the system has received offers to sell products that are related to or compatible with the product viewed by the user, for example, and accessory.

In one embodiment, the system determines 1704, based at least in part on the user's browsing activity, whether a product displayed to the user via the webpage is a product of interest to the user. The system may determine that a product is of interest to the user if the user clicks on the product listing (or product link) or adds a product to a shopping cart of the webpage as an example. As another example, the system may determine that a product is of interest to the user if the user spends a certain amount of time viewing a product listing, e.g., more than 10 seconds, without scrolling past the product listing. Once the system determines the product is of interest to the user, the system may capture or record the product details and associated price and determine whether the system has a comparable product to offer to the user.

The system may receive 1706 offers from one or more seller's offering products for sale. In some forms, the web browser extension calls an API to interface with the virtual inventory database of the system and/or sellers offering comparable products and receives this product information. In some forms, retailers and sellers list or enter products into the system for the system to offer to the user when the system determines a user may be interested in the product or is browsing or has browsed for similar products. The retailers and sellers may provide a price they desire to sell or offer the product at. In one form, the retailers and sellers provide a floor or a minimum price they are willing to sell their products at. The system, upon determining the price of the product a user is viewing in their browser may determine whether the minimum price the retailer and seller products are listed for is lower than the price listed on the webpage. If so, the system may present the product of the retailer or seller to the user at the minimum price. In another form, the system may be configured to undercut the price offered by the webpage for the incumbent product by a percentage unless it would result in a sale for less than the minimum amount listed by the retailer and seller. For instance, the seller may select to undercut the incumbent product of the webpage by 5%. Thus, if a product is listed on a webpage for $100 and the system has an offer from a retailer to sell a comparable product for no less than $90, the system may offer the product to the user for $95 (undercutting the listing on the webpage by 5%). In some instances, the system may offer products to the user that do not have a lower price than the product displayed on the web page. This may occur when the comparable product is of higher quality or a better brand than the product displayed to the user on the webpage the user is browsing. Thus, the system may be configured to offer the retailer or seller products to the user based on the fact that the products are comparable or related and not solely based on the price difference with the product displayed on the webpage.

In other forms, the system may solicit bids from retailers and sellers for comparable products in real time as the system determines users are browsing or interested in various product on a webpage. In these forms, the system may send a notification to or alert the retailers and sellers of products that a user is currently browsing or that the system has determined is of interest to the user. The retailers and sellers may, upon receiving the product information and price of the product the user has viewed or interested in, may place a bid or offer to present to the user for consideration.

The system displays 1708 one or more offers for the comparable product from the sellers to the user via the web browser. The system may be configured to notify the user as they are browsing that the system has comparable products the user may purchase Products listed in the virtual inventory of the system may be presented to the user immediately while the system sources bids from other sellers in real time Once a bid from a seller has been received, the system may present the bid to the user via the extension. In other forms, the system may notify or present offers from sellers to the user at a later time (e.g., even if the user is not currently shopping). The system may be configured to notify the user if the product is the same or a lower price to the product displayed to the user on the webpage. The system may notify the user via a popup in the user's browser that shows the user the comparable product offered by a seller of the system along with the price. The popup offering to sell the comparable product of the system may appear next to the associated product on the webpage. In another form, the system provides an indication to the user that comparable products are available through the system. The user may then to click on the indication, such as a popup notification or virtual button of the browser extension, to view the comparable product and price. In another form, the system may send the offer to the user in an email.

Where multiple retailers or sellers have competing offers for products that are comparable to the products viewed by the user, the system may display multiple offers from multiple sellers. The offers may be displayed to the user in a separate window or may be presented in a box over the webpage displayed by the web browser. In other forms, the offers are listed in an email. All offers provided by the system to the user may be listed for the user to scroll through. In some forms, the offers provided to the user are presented with the lowest priced offer at the top of the list. In some forms, offers from verified resellers are listed at the top with the offers from verified resellers being presented to the user in order based on the price (e.g., lowest to highest). In embodiments where the user is associated with a concierge representative (as described in further detail below), the bids or opportunities presented by the user's concierge representative may be presented at the top of the list of offers above the verified resellers.

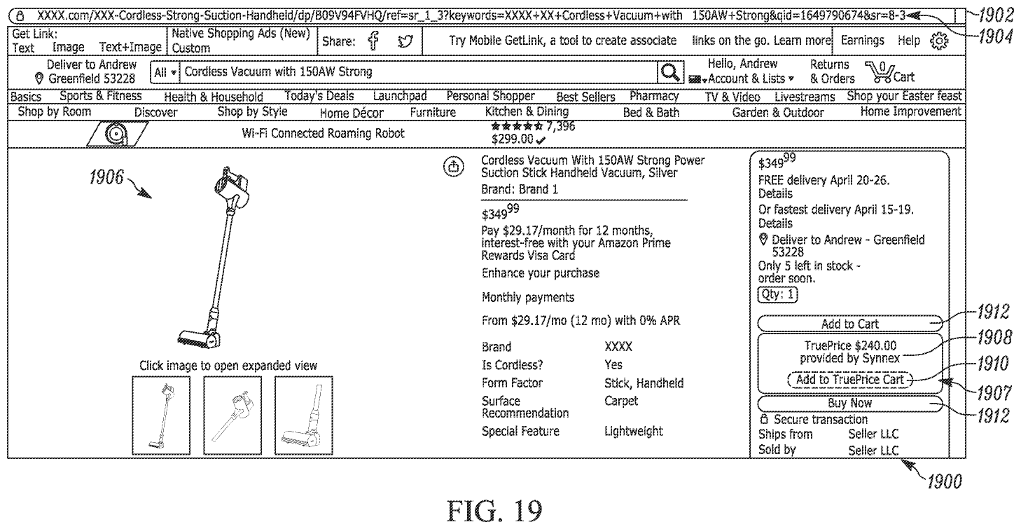

As one example, and with respect to FIG. 19, the system may monitor the user's browsing activity and, when the system determines the user is viewing a website listing items that the user may purchase via the website, the system may present the user with an option to purchase these or similar items from alternative sellers. The system 1900 includes a software file including a web browser extension 1902 that may be installed on a user's web browser 1904 as described above. The web browser extension 1902 is associated with and/or includes a remote server computer of the system that provides functionality to the web browser extension 1902. The web browser extension 1902 may be configured to monitor the websites 1906 that the user visits as described above and determine when the user is on a webpage or website offering an item for sale to the user, such as an e-commerce site. The web browser extension 1902 may determine whether a user may purchase an item from the website 1906 by searching for features on the webpage such as text or virtual buttons of the graphical user interface that the user may interact with to facilitate the purchase of an item. For example, the web browser extension 1902 may scan or search for indicators or text on the webpage such as “add to cart,” “buy now,” “continue to checkout” and similar phrases that indicate the user may purchase an item displayed on the webpage and/or that the webpage includes a conventional checkout feature. The web browser extension 1902 may also search for other indicators that the website includes a purchasable product such as, as examples, price information and manufacturer part numbers.

Upon detecting the user may purchase an item displayed on the webpage, the web browser extension 1902 may search the webpage for details about the item presented to the user for purchase to identify the purchasable item of the webpage. For example, these details may include the manufacturer part number, a product name or title, a description of the product, a manufacturer name, and the like. The web browser extension may compare the product data identified or scraped from the website with product data of a product database or inventory listing associated with the web browser extension 1902. The product database may be a database listing all of the items the web browser extension 1902 is able to offer for sale along with information about each item such as how many are left in stock. Alternatively or additionally, the web browser extension may search or crawl the internet and/or the websites of other stores to find comparable product offerings. Where the web browser extension 1902 is not able to identify a product identifier (e.g., manufacturer part number) on the website, the web browser extension 1902 may compare the product title and/or description found on the website with the product title and/or description information stored in the product database of the web browser extension 1902. The web browser extension 1902 may require that the product description and/or title of the website match an item title and/or description of the product database with a predetermined minimum degree of correspondence before determining a product match has been found in the product database. For example, the web browser extension 1902 may be configured to require a 90% correspondence or match between the product title/description of the website and the product title/description of an item listed in the product database of the web browser extension 1902.

When the web browser extension 1902 determines that a match or comparable product has been found in the product database of the web browser extension 1902 (or on another website), the web browser extension 1902 may display this item to the user via the web browser 1904 along with the option to purchase this item from the alternative seller. The option to purchase the item may include an alternate checkout feature that is displayed via the web browser 1904 and/or on the website 1906. The web browser extension 1902 may determine whether to display the comparable product or the order in which the comparable products are displayed based on the distance of the seller from the user (e.g., whether the seller is local or within a predetermined distance), the price of the items (e.g., lowest priced items first), or other parameters. The user may set the parameter or filters for the comparable products that are displayed within the web browser extension.

In the example embodiment shown in FIG. 19, the web browser extension 1902 modifies the display of the website 1906 in the web browser 1904 to include an alternate checkout 1907. The alternate checkout 1907 may include a text box 1908 indicating that the item the user was viewing on the website (e.g., a vacuum) is able to be purchased from an alternative seller and lists the price the item can be purchased from the alternative seller. The web browser extension 1902 may also present an interface, such as a virtual button 1910, through the web browser 1904 that the user may click on or select to proceed to purchase the item from the alternative seller rather than through the website 1906. The web browser extension 1902 thus modifies the display of the website 1906 to include two alterative paths to purchasing the same item from two different sellers (the website and the alternative seller identified by the web browser extension). In other forms, the web browser extension 1902 may provide a popup notification and/or window with the alternate checkout 1907 that the user may interface with to view and purchase the identified comparable products. Providing the user with an alternate checkout presents the user with two options for purchasing the same item or a comparable item that may be priced differently. Users that shop via the internet may install the web browser extension 1902 on their web browser 1904 so that as they shop for items the web browser extension 1902 automatically identifies and presents items and corresponding prices to the user from alternative sellers. A user may thus determine whether the item listed on the website 1906 is priced reasonably, whether the item is priced too high, and/or whether the same item or a comparable item may be purchased at a lower price from another seller. The user, when viewing the listing of the item from the alternative seller presented by the web browser extension 1902 on the web browser 1904/website 1906, may opt to purchase the item from the alternative seller. For example, the user may opt to purchase the item from the alternative seller when the alternative seller is selling the same item at a lower price.

Thus, in some forms, an extension 1902 may be offered for a conventional Internet browser 1904 that allows a user to navigate to any e-commerce site 1906 (e.g., Amazon, eBay, Alibaba, AliExpress, Walmart, Etsy, Rakuten, JD.com, Target, etc.) to search items for sale. The e-commerce site 1906 includes a conventional checkout 1912 (e.g., an “add to shopping cart” button or interface (e.g., GUI, etc.), a “buy now” button/interface, etc.), however, the extension 1902 presents an alternate checkout 1907 (or parallel checkout path) that allows the user to purchase an item through a third party instead of the e-commerce site and thereby allows the third party to gain the retail science associated with the transaction and offer the various alternate pricing options, purchasing options, customer relationship management (“CRM”) options, create purchasing groups to garner better pricing or improve purchasing power, etc. discussed herein. The third party may then process the financial transaction for the good/service purchase, arrange for picking up of the good/service (e.g., where the good/service is available at a local store), arrange for the delivery of the good/service, and other related items to the transaction or for future transactions. The third party may also retain the information gleaned from handling the transaction and use this information for retail science purposes (e.g., to use and sell to others the data collected), and/or to perform customer relationship management services for the customer and/or make other offers, purchasing options (e.g., purchasing groups, bulk/volume purchasing discounts, etc.), delivery options (e.g., better shipping rates or options, etc.), etc. for future sales (with the customer or with others) as described through this disclosure. In one form, the third party collects the shopping data of the consumer and/or collects data related to the financial transaction and frequency of same (if applicable), and/or utilizes this data for its own benefit (e.g., to arrange for group purchases at price discounts, make future purchase pitches to the same consumer or others, etc.), and/or utilizes this data to carry out CRM.

Returning to FIG. 17, when the user determines to purchase a product offered by the system, the system receives 1710 an indication from the user to accept an offer from a seller for the comparable product. The system may display a virtual button (e.g., virtual button 1910) that the user may select, touch, or click on to accept the bid from the seller. As examples, the virtual button may display “accept offer” or “purchase” that indicates to the user to select the button to complete the transaction with the seller. The user may then touch or click on the button to accept the offer from the seller.

Upon receiving an indication that the user would like to accept the offer from a seller, the system adds 1712 the product to a virtual shopping cart of the system. The virtual shopping cart may serve as a consolidated shopping cart that enables a shopper to complete purchases from multiple sellers in one transaction. The virtual shopping cart may operate according to the example method shown in FIG. 18. A user may select to purchase an item a seller. The system receives 1802 an indication from the user accepting the offer from the seller. The system then adds 1804 the item to the consolidated virtual shopping cart associated with the browser extension of the system. A user may continue shopping from one or more websites for products and continue to accept bids or offers presented or displayed via the system. In some forms, the user may even be able to add the products listed on the webpage of an online store to the virtual shopping cart of the system. For instance, where the system is connected to the webpage, the system may be configured to allow the user to add the products of the webpage to the virtual shopping cart of the system to include all items in the same shopping cart. Upon selecting to purchase an additional item, the system receives 1806 the indication of this selection accepting the offer. The product offering may be from a different seller than the seller of the first item the user has selected to purchase. The system then adds 1808 the additional item to the consolidated virtual shopping cart. When the user has completed shopping, the user may complete 1810 the sale of all of the products in the consolidated virtual shopping cart via a single transaction with the user. The user may thus purchase all of the products added to the cart of the system simultaneously even if the products are from different sellers. The user may enter in credit card or payment information once and the system automatically completes the one or more transactions with the sellers by splitting the user's payment to the sellers on the back end. This provides the user with a central interface through which purchases from multiple sellers can be completed quickly, without having to complete separate transactions with the individual sellers to purchase the product from the seller. The virtual shopping cart of the system thus acts as a “super shopping cart” or consolidated shopping cart enabling the user to purchase goods from multiple sellers in one transaction. The system may then hold on to the payment received from the user until the system receives a tracking number from the seller. Once the tracking number is received from the seller, the system may complete the transfer of purchasing funds received from the user to the seller.

The system may maintain a virtual inventory database that includes physical inventory of the system and inventory provided to the system by sellers, suppliers, and other partners. The physical inventory of the system may be inventory physically stored in a warehouse or storage unit that is associated with or linked directly to the system and that is sold exclusively by the system. The system may receive inventory data from other sellers, suppliers, and other partners that desire their inventory be offered for sale by the system. The system may receive inventory data via spreadsheets and other information feeds (e.g., EDI, API, etc.). The system may also receive inventory documents from sellers that include one or more products along with quantity and pricing information. The system may parse these documents and work with these sellers to validate the inventory information. The received inventory data may be added to the inventory data of the physical inventory of the system, if any. In some forms, all of the inventory data is compiled into a virtual inventory database that the system may search to find comparable items. The inventory data may include pricing data for each inventory item. The system may use the pricing data as a raw cost to the system. The system may use a pricing algorithm that uses this raw cost data to determine the prices to offer the goods to a user. For example, the system may sell the inventory at a price higher than the raw cost to make a profit on the sale of a particular good. The system may adjust the price based on the price of the item a user is viewing on a website to undercut the price of the item on the website while still making a profit. The system is thus able to ensure that the pricing of the inventory offered by the system is competitive relative to the items that the user is viewing on a website.

The system may be configured to submit bids or offers to a user on the seller's behalf. For the system to automatically submit a bid or an offer to a user on the seller's behalf, the system may require that the seller provide a guarantee of the amount of product the seller has in inventory. This ensures that the seller has enough inventory on hand to complete the transaction with a user if the user (or multiple users) accept a bid automatically provided to the user. The system may also be configured to only allow sellers that have achieved a “verified reseller” status to participate in the automatic bidding process. This also ensures that the seller will complete the transaction after the user has accepted a bid. When setting up the automatic bidding process for the seller's inventory, the seller may be required to submit the floor or lowest price the seller is willing to sell the goods for as described above. The system may also require that the seller provide an adjustment percentage that will be used to set bid price that is automatically placed by the system. The system will then undercut the incumbent product displayed to a user on a webpage by the adjustment percentage unless the adjusted price is below the floor price provided by the seller.

The system may also be configured to provide live bids to users. Sellers can upload their product information, the amount of product the seller has in inventory, and the price per product. When a user is determined to be viewing a product on a webpage, relevant live bids can be presented to the user at the price entered by the seller into the system.

In some forms, the system may present users with bids or offers for comparable products to those browsed or determined to be of interest to users at a later time. For instance, the system may monitor the browsing activity of a user and may notify, display, or email an offer to a user for a comparable product for the user to consider after they are no longer shopping. In one form, the system presents an offer to a user 24 hours after determining that a user was determined to be shopping for a particular product. The system may further monitor whether a user actually completes a transaction or purchase for the product on the webpage. If the user does not purchase the product, the system may log the user's browsing activity (e.g., the products the user was looking at) and offer a comparable product to the user at a later time. This may be advantageous when the system does not have a comparable product to offer the user while the user is browsing, but later a seller enters or indicates they have comparable products they would like to sell. The system may then present the user with an offer to purchase the comparable product. The system may also present the user with an offer to purchase a comparable product if the system determines the price of a comparable product has been reduced or a new comparable product is available for sale by the system at a lower price than an item determined to be of interest to the user Thus, the system is able to complete sales for alternative sellers (e.g., those providing the system with inventory lists and/or those websites searched or crawled by the system) even after the user is no longer currently viewing a product via the web browser. Another advantage of the web browser extension of the system is that the user is able to automatically receive offers to purchase goods they are interested in at a later time, for instance, when they become available at a lower price or an available comparable item is identified.

A concierge representative is a representative for a seller that has access to the products a user has browsed for. A concierge representative may present an offer for a comparable product to the user based on a review of the user's browsing history (e.g., products the user has viewed within the last 24 hours). These bids or offers may be presented to the user similar to a live bid described above.

In some forms, the bids or offers from the sellers are only valid or active for a certain time period from when they are presented to the user. For example, the offer may be active for only 48 hours before the offer expires. In some embodiments, the user may be able to pay a fee to extend the time the bid or offer is valid. This may give the user more time to consider whether they would like to complete the transaction with the seller of the system or wait for more bids to come in from other sellers of the system. As one example, a user may pay a $1 fee to keep the offer open for an additional 24 hours. Other sellers or concierge representatives may then be able to continue to submit bids or offers for the user to consider.

In some embodiments, sellers, such as concierge representatives or verified resellers, may be able to offer flash sales to users. These flash sales offer products to users at aggressively low prices. The system may require that the price for the flash sale offers be fixed. The system may also limit the number of bids or offers that are presented to users based on the amount of product the seller has in inventory that they are looking to sell. In some forms, to present flash sale offers to users the seller must be an approved vendor (e.g., a verified reseller) and the seller must guarantee that they have a required quantity on hand for the flash sale plus an additional percentage (e.g., if the sale if for 100 items, the system may require the seller have 125 items in inventory) The system may also require that the seller have at least one previous verified sale of the product offered in the flash sale offer.

In some forms, a user may be able to connect with or associate themselves with a concierge representative. The user may be able to provide the concierge representative with a list of items the user desires to purchase and the concierge representative can provide the user with an offer or bid for the list of items for the user to purchase. For instance, if the user is shopping for stationery items for an office, the user can alert the concierge representative of the list of stationery items the user's office needs. This allows the concierge representative to proactively search for items the user needs and put together a bid or offer for some or all of the items requested by the user. This is also advantageous to the user as the user can develop a relationship with the concierge representative to potentially receive contract-based pricing that the concierge representative may have access to. The user can also monitor the concierge representative's activity and consult with the concierge representative regarding the products the user is looking to purchase. The concierge representative may also have expertise or a greater knowledge about the products the user is looking to purchase and may be able to provide the user with recommendations.

In some embodiments, the system provides the user with rewards, points, or tokens upon completing a purchase through the system. For example, if the user places an order for an item displayed via a flash sale, the user may acquire rewards, points, or tokens. The amount of rewards, points, or tokens a user receives may correspond to or be proportional to the cost of the item purchased. For instance, if the user bought an item for $100, the user may receive 1 token. The rewards, points, or tokens may be used by the user to purchase items in place of cash in future purchases through the system. For example, once the user has acquired a certain number of tokens (e.g., 20 tokens), the user may be able to purchase an item using the tokens. In some forms, the user may be able to exchange their tokens for cash, cryptocurrency, credit within the system, or a gift card.

In some embodiments, the system accepts payment from a user for items in a cryptocurrency. In one form, the system provides a cryptocurrency of the system to the user as the reward or token for completing transactions through the system. The user may use or exchange the cryptocurrency of the system to complete transactions through the system. In some forms, it may be required for the user to use the system's currency. The user may also use the cryptocurrency of the system to purchase goods and assets from other sellers and stores, and or exchange the cryptocurrency on an exchange. In one embodiment, the reward, token, or cryptocurrency of the system is a non-fungible token (NFT), for example, a blockchain based NFT rooted in the Ethereum open-source platform. Upon completing a transaction via the system, the user is provided with an NFT or several based on amount purchased. The user may sell their NFT to others or exchange their NFTs for other currency (e.g., other cryptocurrency or cash such as a particular country's denomination, e.g., US Dollar, Euro, Yen, etc.). In some forms, a user may use their NFT in a gaming system and place bets and/or gamble with their NFT rewards.

In one embodiment, the system provides an interface for sellers to set up their website and to list inventory to be presented to buyers shopping on their website store and to be presented as a local option via the web browser extension as described above. The seller interface may include a feature enabling a seller to upload inventory to the seller's website or virtual store on the system. The seller may have an inventory sheet file of inventory the seller would like to sell that includes, for example, part numbers, part descriptions, quantity information, and price information. The seller, using a computer, may drag and drop the inventory sheet file onto a region of the interface of the system to list the inventory for sale via their website store and/or to be presented as an alternative comparable product or local option through the web browser extension. Upon dragging and dropping of the inventory sheet file, the inventory file is uploaded to the system. The system may then parse the inventory file to determine which parts or products are included, a description of each part or product, quantity of each part or product, and a price for each part or product. Upon parsing the inventory file, the system may present an inventory listing for the user to review to confirm the inventory file was parse correct before adding the inventory data to the seller's website store. In another form, the seller may enter the part inventory data manually or update the inventory information as they receive new inventory to sell.

Once uploaded, buyers may purchase the inventory from the seller via the system, for example, on the seller's online store webpage. Buyers may download a web browser extension of the system to permit the system to monitor and track their browsing and shopping activity. The system may monitor the browsing activities of other buyers on the system to determine if the buyers are searching or shopping for product that is the same or comparable to that which is listed by the seller. The system may provide the buyer with a notification via the web browser extension or otherwise of the same or similar goods offered by a seller of the system at a lower price. The system may periodically search for items the buyer has been searching for and alert the buyer of times the system determines to be opportune for purchasing those items. As one example, when a seller lists items that are the same, similar, or interchangeable with items the buyer has been searching for, but at a lower price than the items previously on the market, the system may notify the user of the new product listing or new price to provide the user with the option to purchase the goods at the lower price. The system also presents users purchasing products from other online marketplaces (e.g., upon adding an item to their shopping cart) with the option to purchase the same or a similar item from the seller via the web browser extension. The system may present the system's seller's products as an alternative to purchasing from the online marketplace. Each seller may select or configure the system to price their products at a price lower than those on the online marketplace to present the buyer with a cheaper option for the same or comparable product. The seller may select a floor price that will limit the system from lowering the price of the product beyond the floor price, for example, to ensure the seller still makes a profit on the sale. The system may also present the item to the buyer as an option to keep the transaction local and support local businesses, where the online buyer is within a predetermined proximity to the seller's listed address.

According to another aspect, the system may include a user device application that users may download onto their user devices (e.g., smartphones, computer tablets, etc.). The application may include a feature that notifies other users of the application in the area when one user is going to a store, restaurant, or the like to purchase an item. The other users may use the application to ask the user going to the store pick an item up for them and deliver it to their home. For example, a first user decides to head to the grocery store to purchase one or more items. The first user uses the application of the system to enter their destination and to broadcast to other users of the application that they are heading to the grocery store. The broadcast may be limited to those within a certain area of the destination or user, for example, those within one square mile. In another example, the broadcast may be limited to those within a certain distance from the first user's home (e.g., within 1 mile). The other users may receive a notification or may view that the first user is heading to the grocery store within the application. The system may permit the users to have the first user pick up an item from the grocery store for them. The users may enter one or more items they would like from the grocery store (where the first user is headed or at) that they would like the first user to purchase for them. The first user may receive a notification or message in the application of the items users would like them to purchase from the grocery store. The first user may accept to fulfill the other user's request. The first user may purchase the goods and drop them off at the other user's home or desired drop off location.

While a grocery store is provided in the above example, those having skill in the art will readily appreciate that any business selling goods (e.g., home improvement stores, restaurants, computer store, bookstore etc.) may similarly be used to permit users of the application to purchase and receive goods from a local store without having to leave their home by employing another user heading to or at the store to purchase the goods on their behalf. This permits users to purchase items from a local store and receive the items within a short period of time without having leave their home and/or without having to stop at the store themselves. Thus, a user who does not desire to head to the store to shop may have another user heading to the store shop for them and deliver them to their home or desired destination (e.g., work). This provides an alternative to the user purchasing the items from an online marketplace due to their desire not to go or inability to go to the store to shop for the items themselves. Additionally, this may reduce emissions where the first user lives in the same area as the user for whom they are purchasing items for.

In another form, a user may use the application to place one or more items in a shopping cart of things they would like from a store and when other users are at that store, they may opt to purchase and deliver the items to the user. For instance, a user may create a shopping list within the application of items to purchase from the store, for example, the next time they go to that store. When other users are at that store, they may be notified or may view within the application that another user would like one or more items from that store and where they would like the items delivered. The user may be notified if they live within a predetermined proximity to the user's home or desired delivery location (e.g., one mile). The user may select to purchase the items on the shopping list and deliver them to the user. Thus, a user may keep a running shopping list that other users may opt to fulfill on behalf of the user so that the user may not have to go to the store themselves at a later time or purchase the goods from an online marketplace or store.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A method for providing a user with offers to purchase merchandise, the method comprising:
monitoring browsing activity of a user on a web browser application of a user device via a web browser extension;
determining a product of interest to the user based at least in part on the browsing activity;
displaying, via the user device, an offer to purchase a comparable product to the determined product of interest; and
adding the comparable product to a virtual shopping cart associated with the user and the web browser extension.

2. The method of claim 1 further comprising:
receiving, at a remote computer associated with the browser extension, product listings from one or more sellers of one or more products to offer for sale; and
determining, based on a comparison between the product listing and the determined product of interest, the comparable product to offer to the user.

3. The method of claim 1 wherein the comparable product is added to the virtual shopping cart upon receiving an indication from the user to accept the displayed offer for the comparable product.

4. The method of claim 1 wherein monitoring the browsing activity of a user includes collecting information pertaining to products viewed by a user.

5. The method of claim 4 wherein collecting information includes keeping a record of webpages visited by a user.

6. The method of claim 4 wherein collecting information includes scanning the webpage displayed to the user for a displayed product and a list price.

7. The method of claim 6 wherein scanning includes using optical character recognition.

8. The method of claim 1 wherein the offer for the comparable product is displayed to the user via at least one of the web browsers, via a notification to the user device, and via a message to a user account associated with the user.

9. The method of claim 1 wherein a determination of a product of interest to the user is based at least in part on the amount of time the user viewed the product.

10. A system for presenting relevant products to a user, the system comprising:
a remote server computer;
a web browser extension communicatively coupled to the remote computer and configured to be added to a web browser application of a computing device, the web browser extension, in conjunction with the remote server computer, being configured to:
monitor browsing activity of a user on a web browser application of a user device via the web browser extension;
determine a product of interest to the user based at least in part on the browsing activity;
display, via the computing device, an offer to purchase a comparable product to the determined product of interest; and
add the comparable product to a virtual shopping cart associated with the user and the web browser extension.

11. The system of claim 10 wherein the web browser extension, in conjunction with the remote server computer, is further configured to:
receive, at the remote server computer, product listings from one or more sellers of one or more products to offer for sale; and
determine, based on a comparison between the product listing and the determined product of interest, the comparable product to offer to the user.

12. The system of claim 10 wherein the comparable product is added to the virtual shopping cart upon receiving an indication from the user to accept the displayed offer for the comparable product.

13. The system of claim 10 wherein monitoring the browsing activity of a user includes collecting information pertaining to products viewed by a user.

14. The system of claim 13 wherein collecting information includes keeping a record of webpages visited by a user.

15. The system of claim 13 wherein collecting information includes scanning the webpage displayed to the user for a displayed product and/or a list price.

16. The system of claim 15 wherein scanning includes using optical character recognition.

17. The system of claim 10 wherein a determination of a product of interest to the user is based at least in part on the amount of time the user viewed the product.

18. The system of claim 10 wherein the offer for the comparable product is displayed to the user via at least one of the web browser, via a notification to the user device, and via a message to a user account associated with the user.

19. A method for completing the purchase of products from a plurality of sellers via a single transaction, the method comprising:
receiving an indication from a user accepting an offer from a first seller for a first product;
adding the first product from the first seller to a consolidated virtual shopping cart associated with a browser extension;
receiving an indication from a user accepting an offer from a second seller for a second product;
adding the second product from the second seller to the consolidated virtual shopping cart; and
completing the sale of the products in the consolidated virtual shopping cart associated with the browser extension via a single transaction with the user.

20. The method of claim 19 wherein at least one of the first seller and the second seller is an online store.

21-37. (canceled)
